(19) United States
(12) Patent Application Publication
(10) Pub. No.: US 2013/0008890 A1
(43) Pub. Date: Jan. 10, 2013

(54) REACTOR METHOD OF MANUFACTURE FOR SAME

(75) Inventors: Junichi Esaki, Nagoya-shi (JP); Yoshitomo Kajinami, Nagoya-shi (JP); Hiroyuki Kato, Nakatsugawa-shi (JP); Yasuhiro Matsumoto, Nakatsugawa-shi (JP)

(73) Assignees: DAIDO ELECTRONICS CO., LTD., Nakatsugawa-shi, Gifu (JP); DAIDO STEEL CO., LTD., Nagoya, Aichi (JP)

(21) Appl. No.: 13/636,099

(22) PCT Filed: Mar. 17, 2011
(86) PCT No.: PCT/JP2011/056473

§ 371 Date: Sep. 19, 2012

(30) Foreign Application Priority Data
Mar. 20, 2010 (JP) 2010-065307
Mar. 20, 2010 (JP) 2010-065309
Mar. 20, 2010 (JP) 2010-065310
May 8, 2010 (JP) 2010-107793

(51) Int. Cl. H05B 6/22; H01F 41/00

(52) U.S. Cl. 219/647; 29/602.1

(57) ABSTRACT

[Problem] When a core is configured by injection-molding a mixture including a soft magnetic powder and a thermoplastic resin and a reactor is manufactured by integrating a coil in a state where the coil is embedded in the inner portion of core, positional misalignment or deformation of coil at the time of molding the core can be effectively prevented, and the core can be favorably molded using an injection molding method.

[Solution Means] A reactor 15 is manufactured through a step A of encasing a coil 10 configured by winding a wire in a state where an insulating layer is interposed between the wires with an electrically insulating resin to mold an encased coil body 24, and a step of molding a core 16 by injection-molding a mixture including a soft magnetic powder and a thermoplastic resin in a state where the encased coil body 24 is enclosed. In addition, the injection molding of the core 16 is performed so as to be divided into a step in which a primary molded body 16-1 having a container shape alone is molded and a step in which a secondary molded body 16-2 is molded in a state where the encased coil body 24 is set along with the primary molded body 16-1.

### TECHNICAL FIELD

The present invention relates to a reactor in which an electric coil is integrally formed with a core having soft magnetism in an embedded state in the inner portion of the core, and a method of manufacture for the same.

### BACKGROUND ART

As a representative example of a coil composite molded body, there has been known a reactor which is an inductance part, and which is a form where an electric coil (hereinafter, there may be a case where the electric coil is simply referred to as a coil) is included in an embedded state in the inner portion of a core formed of a molded body (soft magnetic resin molded body) configured of a mixture of a soft magnetic powder and a resin.

In hybrid vehicles, fuel cell vehicles, electric vehicles, or the like, a booster circuit is provided between a battery and an inverter which supplies alternating current power to a motor (electric motor), and a reactor (choke coil) which is an inductance part is used in the booster circuit.

For example, in hybrid vehicles, a maximum voltage of the battery is approximately 300 V. On the other hand, it is necessary to apply a high voltage of approximately 600 V to the motor so as to obtain large output. Therefore, a reactor is used as a part for the booster circuit.

A reactor is widely used for the booster circuit in photovoltaic power generation, or the like.

Conventionally, as the reactor, there has been generally used one in which a coil is wound around the periphery of a core which is configured so that a pair of U-shaped core pieces is disposed in a state where a predetermined gap is generated between end surfaces of each of the core pieces.

However, in the case of this type of reactor, since the coil is exposed to the outside, there are problems in that coil vibration occurs according to excitation of the coil and becomes noise, the dimensions of the gap between the coil pieces should be determined with high accuracy, an assembly process between the core and the coil is needed, and the like. Therefore, there has been proposed a reactor in which a core is configured of a molded body (soft magnetic resin molded body) including a mixture of a soft magnetic powder and a resin and the coil is integrally included in an embedded state in the inner portion of the core.

For example, Patent Literature 1 and Patent Literature 2 below disclose this type of reactor and a method of manufacture for the same.

In methods of manufacture for the reactor disclosed in Patent Literature 1 and Patent Literature 2, a mixture, in which soft magnetic powder is mixed in a dispersion state in liquid of a thermosetting resin, is injected into the inner portion of an outer case or a container in a state where a coil is set to the inner portion of the outer case or the container, and thereafter, this is heated to a predetermined temperature and the resin liquid is subjected to a hardening reaction for a predetermined time, so that a core is integrated with the coil at the same time as the core is molded (this is according to a method referred to as a so-called potting method).

In the case of the reactor which is obtained in this manner, there are advantages that occurrence of noise due to the coil vibration can be prevented, setting the gap between the core piece and the core piece with high accuracy is not needed (a minute gap is formed between the magnetic powders of the molded body core), the assembly process between the core and the coil is not needed, the coil can be protected from the outside by the core (soft magnetic resin molded body), and the like.

However, on the other hand, in a case of the above-mentioned method of manufacture for the reactor, since a large heating furnace is needed for hardening the liquid of the resin including the soft magnetic powder, a large amount of thermal energy is needed for the hardening, and a long time is required for the hardening, there are problems in that the costs are increased and increasing the productivity is difficult.

Accordingly, as a method of manufacture for the reactor, a method is considered in which the electric coil is set into a cavity of a molding die and the mixture including the soft magnetic powder and a thermoplastic resin is injected into the cavity, so that the core is whereby injection-molded and also the coil is integrated in an embedded state in the inner portion of the core.

According to the method for manufacture using the injection-molding, various problems included in the manufacture methods disclosed in Patent Literature 1 and Patent Literature 2 can be solved.

However, in this case where the mixture of the soft magnetic powder and the thermoplastic resin is directly injected into the cavity in the state where the coil is set into the cavity, as schematically shown in FIG. 21, the soft magnetic powder 14 (hard metal iron powder or the like is used as the soft magnetic powder 14) strongly strikes an insulating coating 12 on a surface of a wire 11 of the coil 10 or scratching occurs (in the case of the core of the reactor, generally, approximately 50 to 70% in terms of volume % of the soft magnetic powder such as the iron powder is contained) due to the injection pressure or the flow pressure in the cavity, and whereby, there occurs a problem that damage such as tearing of the insulating coating 12 on the surface of the coil 10 occurs.

In general, a coil with attached insulating coating is used as the coil 10, in which a wire 11 in which the insulating coating 12 has been attached and formed on the outer surface thereof in advance is wound. Generally, a liquid (varnish) having a predetermined viscosity, which is formed by dissolving an insulating resin (for example, polyamide-imide) in a solvent, is coated on the entire outer surface of the wire 11 which forms the coil 10, and thereafter, the coated wire is subjected to a drying and a hardening reaction for film formation, whereby the insulating coating 12 is obtained. However, the film thickness of the insulating coating 12 is thin at approximately 25 μm, and the insulating coating 12 may be damaged if the soft magnetic powder 14 such as iron powder strongly strikes the insulating coating 12 or scratching occurs at the time of the injection-molding.

If the insulating coating 12 is damaged in this manner, insulating performance of the coil 10 is decreased, and voltage resistance (resistance to dielectric breakdown voltage) characteristics in the reactor are decreased.

In addition, when the coil is set into the cavity and the mixture which includes the soft magnetic powder and the thermosetting resin is injection-molded, there occur problems that positioning of the coil in the cavity is difficult, the coil itself is simply deformed by elongation like an accordion or is easily deformed by twisting, and when the mixture which includes the soft magnetic powder the thermosetting resin is injected into the cavity, the coil is misaligned from the set position or is easily deformed due to the injection pressure or the flow pressure.

In this case, the coil is misaligned from a regular position or is deformed, and therefore, the performance for a reactor is damaged.

Moreover, when the injection-molding is performed as described above, there occurs difficult problems that cracks occur in the core as a molded body due to expansion through heating and shrinkage through cooling at the time of molding, and that heat stress is applied to the insulating coating and the insulating coating is also damaged at this time.

For example, the temperature of the mixture of the soft magnetic powder and the thermoplastic resin at the time of the injection into the cavity of the molding die is 300° C. or more in a liquid of a molten state, and after the injection, the mixture is cooled through the molding die in the inner portion of the molding die and solidified, and becomes a molded body.

At this time or thereafter, in the process in which the molded body is taken out from the molding die and is cooled to room temperature, the core which is the molded body tends to largely shrink in the radial direction.

However, since the coil made of a metal is positioned in the inner portion of the core, the core cannot shrink in the radial direction in the outer circumferential side of the coil (there is a great difference in a thermal expansion coefficient between the core and the coil made of a metal), as a result, the outer circumferential portion of the coil is shrunk in the circumferential direction, and as shown in FIG. 22, a crack K occurs in an outer circumferential molded portion 16A of the core 16.

The occurrence of the crack K in the core 16 becomes a factor which decreases the performance for the reactor.

In addition, great stress (thermal stress) acts on the insulating coating 12 of the coil 10 due to difference of the shrinkage amount between the core 16 and the coil 10 when the core 16 is shrunk, and thus, distortion occurs on the insulating coating 12, and the insulating coating 12 is broken or damaged due to the distortion, or the like.

This also adversely affects the voltage resistance characteristics for the reactor.

In addition, as described above, since the film thickness of the insulating coating 12 on the surface of the wire 11 in the coil 10 is thin, there is a problem in that reliability of the voltage resistance characteristics is not originally sufficient.

The above case is the case where the coil with attached insulating coating is used. However, even when the wire with attached insulating coating is not used, and a coil in which the wire is configured to be wound in a state where an insulating film is interposed between uncoated wires is used, there are problems that the coil is deformed at the time of molding a core, the reliability of the voltage resistance characteristics are not sufficient, and the like, which are similar to the case where the coil with attached insulating coating is used.

Moreover, other conventional arts related to the present invention are disclosed in Patent Literature 3 to Patent Literature 7 below.

Patent Literature 3 describes an invention related to an inductor, wherein a hollow coil which is wound in alpha-shaped windings is received in the inner portion of a navel attached pot core, a thin electrode is formed at terminals of the navel attached core using a dip method, and terminals of the coil are electrically connected to the electrode, whereby connection terminals which are a separated part conventionally needed become unnecessary and miniaturization of the inductor is achieved.

In Patent Literature 3, an aspect ratio in the longitudinal cross-section of the coil is not referred.

Also in Patent Literature 4, there is disclosed an inductor in which the similar alpha-shaped winding coil is configured so as to be received in the inner portion of the pot core. However, also in the Patent Literature 4, an aspect ratio in the longitudinal cross-section of the coil is not disclosed.

Moreover, Patent Literature 5 discloses that spectacles type coil in which two edge-wise coils are horizontally connected to each other is used. However, in Patent Literature 5, two edge-wise coils are superposed to each other in the same axis.

In Patent Literature 6, an invention regarding a reactor is disclosed, and a reactor having a form, in which an edge-wise coil is disposed in the inner circumference and a coil (is not a flat-wise coil) in which a rectangular wire is spirally wound is disposed outside, is disclosed.

However, in the reactor disclosed in Patent Literature 6, the reactor is a composite reactor which has two functions in a single body by sharing a core by two separated reactors, and therefore, it is not a reactor which has a purpose of miniaturization.

Patent Literature 7 shows an invention regarding a magnetic element, and discloses that a cross-section of a wire in a coil is made rectangle and a ratio (aspect ratio) of the size of a long side with respect to the size of a short side in the wire is highly set so as to be approximately 10, whereby an increase in a direct current resistance when the number of turns of the coil is increased is suppressed, and equivalent inductance is improved.

Moreover, in the embodiment of FIGS. 5 and 6, it is disclosed that a first coil and a second coil each configured by winding a wire in the thickness direction are superposed in two stages up and down.

However, in the magnetic element disclosed in Patent Literature 7, the coil is not housed in the core in the state where the coil is entirely enclosed with a soft magnetic core. Moreover, the magnetic element disclosed in Patent Literature 7 pays attention to the aspect ratio of the wire itself of the coil and does not define the aspect ratio of the cross-section shape of the coil itself, and the object thereof does not aim weight reduction and loss reduction of the reactor.

As other conventional arts related to the present invention, there may be mentioned those disclosed in Patent Literature 8 and 9 below.

Patent Literature 8 shows an invention regarding an inductance part and a method of manufacture for the same, which discloses that core materials are made different from each other at the inner circumferential portion and the outer circumferential portion of a coil in a core, the inner circumferential portion is configured of the core material which uses Fe-based soft magnetic powder having a small Si content, and the outer circumferential portion is configured of the core material which uses Fe-based alloy soft magnetic powder having a large Si content.

However, problems of the present invention cannot be solved by that disclosed in Patent Literature 8.

Patent Literature 9 shows an invention related to an inductor and a method of manufacturing the same, which discloses that a first magnetic body of a core is configured of a core material which uses soft magnetic powder having a Fe content of more than 98.5%, and a second magnetic body is configured of a core material which uses stainless powder having a composition of Fe-9.5Cr-3Si as the soft magnetic powder.

However, problems of the present invention cannot be also solved by that disclosed in Patent Literature 9.

Still another conventional art related to the present invention are disclosed in Patent Literature 10 below.

Patent Literature 10 shows an invention related to “a method and a device of manufacturing an electromagnetic coil”, and as a conventional art with respect to the invention disclosed in Patent Literature 10, the followings are disclosed, that is, a sheet conductor (wire) and an insulating sheet such as a PET film are wound in a state of being wound together in a predetermined frequency, and thereafter, an insulating layer of the outside in the width direction is formed by an epoxy prepregs tape and the insulating layer is heat-hardened.

However, that disclosed as the conventional art becomes an obstacle for the miniaturization of the coil.

### CITATION LIST

### Patent Literature

Patent Literature: JP-A-2007.27185
Patent Literature: JP-A-2008-147405
Patent Literature: JP-A-2007-305665
Patent Literature: JP-A-2007-96181
Patent Literature: JP-A-2008-192649
Patent Literature: JP-A-2006-310550
Patent Literature: JP-A-2002-43140
Patent Literature: JP-A-2006-261331
Patent Literature: JP-A-2009-224745
Patent Literature: JP-A-2000-21669

### SUMMARY OF THE INVENTION

### Problems that the Invention is to Solve

The present invention has been made in consideration of the above-described circumstances, and an object thereof is to effectively prevent a soft magnetic powder which is a component of a core from striking an insulating coating of a coil to damage the insulating coating at the time of molding the core and to effectively alleviate heat stress which acts on the insulating coating due to shrinkage of the core in the course of configuring a reactor by making a molded body configured of a mixture of the soft magnetic powder and a resin as a core and integrating the coil with the core in an embedded state in the inner portion of the core.

In addition, another object of the present invention is to solve a problem in which a cracks generates in the core due to shrinkage according to cooling of the core.

Moreover, still another of the present invention is to effectively prevent occurrence of positional misalignment or deformation of the coil at the time of molding the core.

### Means for Solving the Problems

Claim 1 relates to a reactor, which comprises: a molded body configured of a mixture including a soft magnetic powder and a resin as a core, and an electric coil configured by winding a wire in a state where an insulating layer is interposed between said wires, which is configured so as to be integrated with the core in an embedded state in an inner portion of the core, wherein the coil is encased in a state of being entirely enclosed with an electrically insulating resin from the outside to configure an encased coil body, and the core is configured of a molded body formed by injection-molding a mixture including the soft magnetic powder and a thermoplastic resin in a state where the encased coil body is integrally embedded in the inner portion of the core.

Claim 2 relates to a reactor according to claim 1, wherein in the core, a primary molded body, which includes a tubular outer circumferential molded portion contacting an outer circumferential surface of the encased coil body, and a secondary molded body, which includes an inner circumferential molded portion contacting an inner circumferential surface of the encased coil body, are joined to each other at a boundary surface and are integrated.

Claim 3 relate to a reactor according to claim 1 or 2, wherein the resin covering layer of the encased coil body is configured of an injection-molded body of an insulating thermoplastic resin; and a molded body, which includes an outer circumferential covering portion covering an outer circumferential surface of the coil, and another molded body, which includes an inner circumferential covering portion covering an inner circumferential surface of the coil, are joined and integrated.

Claim 4 relates to a reactor according to any one of claims 1 to 3, wherein the coil is a coil which is configured by winding a rectangular wire, the coil is configured in a shape in which a plurality of coil blocks are superposed in the same axis via an insulating sheet in a height direction which is a coil axial direction and/or in a radial direction and in a direction perpendicular to a winding and superposing direction of the wire in a state where the plurality of coil blocks are connected to one another, and an aspect ratio A/B is in a range of 0.7 to 1.8 wherein when a height size is taken as A and a width direction size which is a radial direction size is taken as B in a longitudinal cross-section of the coil including the insulating sheet.

Claim 5 relates to a reactor according to claim 4, wherein the coil is a flat-wise coil which is configured by winding the rectangular wire in a thickness direction of the wire, and the coil blocks are stacked in a plurality of stages in the height direction.

Claim 6 relates to a reactor according to any one of claims 1 to 5, wherein the soft magnetic powder is a powder of pure Fe or a powder of an Fe-based alloy having a composition containing 0.2 to 9.0 mass % of Si.

Claim 7 relates to a reactor according to any one of claims 1 to 6, wherein the inner circumferential portion and the outer circumferential portion of the coil in the core are configured of materials which are different from each other, the outer circumferential portion is configured of a core material which uses a powder of a low Si material configured of pure Fe or an Fe-based alloy containing 0.2 to 4.0 mass % of Si as the soft magnetic powder, and the inner circumferential portion is configured of a core material which uses powder of a high Si material configured of an Fe-based alloy containing 1.5 to 9.0 mass % of Si as the soft magnetic powder and having a larger Si content than the soft magnetic powder of the core material of the outer circumferential portion.

Claim 8 relates to a reactor according to claim 7, wherein the Si content of the high Si material is 1.5 mass % or more larger than a Si content of the low Si material.

Claim 9 relates to a reactor according to any one of claims 1 to 8, wherein the coil is a flat-wise coil in which a rectangular wire to which an insulating coating is not attached is wound in the thickness direction of the wire in a state where an insulating film molded in a film shape in advance is interposed between said wires.

Claim 10 relates to a reactor according to any one of claims 1 to 9, wherein the core is integrally injection-molded with a container portion of a reactor case.

Claim 11 relates to a reactor according to any one of claims 1 to 10, wherein the reactor is to be used in an alternating magnetic field with a frequency of 1 to 50 kHz.

Claim 12 relates to a method of manufacture for a reactor according to claim 1, wherein the reactor is obtained by performing a step A of encasing the coil with the electrically insulating resin in a state where the coil is entirely enclosed from the outside to mold the encased coil body; and a step B of setting the encased coil body to a molding die and injection-molding a mixture including the soft magnetic powder and the thermoplastic resin in a state where the encased coil body is enclosed, thereby molding the core and also integrating the coil in an embedded state in the inner portion of the core.

Claim 13 relates to a method of manufacture for a reactor according to claim 12, wherein the step B of injection-molding the core is divided into a step B-1 in which a primary molded body which includes a tubular outer circumferential molded portion of the core contacting the outer circumferential surface of the encased coil body and includes a shape having an opening for inserting the encased coil body in one end side in the coil axial direction is injection-molded in advance in a primary molding die for the core, and a step B-2 in which a secondary molded body which includes an inner circumferential molded portion contacting the inner circumferential surface of the encased coil body is molded in a secondary molding die for the core, wherein in the step B-2, the secondary molded body which includes the inner circumferential molded portion is molded in a state where the encased coil body is fitted to the outer circumferential molded portion of the primary molded body obtained through the step B-1 in the state of being innerly fitted and the outer circumferential molded portion is held so as to be constrained in the radial direction from the outer circumferential side in the secondary molding die for the core, and simultaneously, the secondary molded body, the primary molded body, and the encased coil body are integrated with one another.

Claim 14 relates to a method of manufacture for a reactor according to claim 13, wherein in the step B-1 in which the primary molded body is molded, a bottom portion of the core opposite to the opening is molded along with the outer circumferential molded portion, whereby the primary molded body is formed in a container shape having a bottom portion in which the encased coil body is housed and held in the inner portion thereof.

Claim 15 relates to a method of manufacture for a reactor according to claim 14, wherein the primary molded body is molded so as to have a height in which the encased coil body is housed over the entire height of a recess of the inner portion.

Claim 16 relates to a method of manufacture for a reactor according to any one of claims 13 to 15, wherein in the step B-2 in which the secondary molded body is molded, a cover portion which closes the opening is molded along with the inner circumferential molded portion.

Claim 17 relates to a method of manufacture for a reactor according to any one of claims 12 to 16, wherein in the step A in which the encased coil body is molded, the resin covering layer which encases the coil in a state of enclosing the coil is injection-molded by the thermoplastic resin, and the injection-molding is performed with dividing the step A into a step A-1 and a step A-2, wherein the step A-1 includes contacting a primary molding die for the resin covering layer with respect to an inner circumferential surface or an outer circumferential surface of the coil, and injecting a resin material into a primary molding cavity of the primary molding die which is formed on the outer circumferential side or the inner circumferential side of the coil in a state where the coil is constrained by the primary molding die so as to be positioned in a radial direction in the inner circumferential surface or the outer circumferential surface, thereby molding a primary molded body which includes an outer circumferential covering portion or an inner circumferential covering portion in the resin covering layer and also integrating the primary molded body and the coil, and the step A-2 includes, after the step A-1, setting the primary molded body along with the coil to a secondary molding die for the resin covering layer, and injecting the resin material into a secondary molding cavity of the secondary molding die which is formed on the inner circumferential side or the outer circumferential side of the coil, thereby molding a secondary molded body which includes the inner circumferential covering portion or the outer circumferential covering portion in the resin covering layer and also integrating the secondary molded body, the coil, and the primary molded body.

Claim 18 relates to a method of manufacture for a reactor according to any one of claims 12 to 17, wherein the coil is obtained by winding a long rectangular wire along with an insulating film molded in a long film shape with a width corresponding to the rectangular wire in advance, so as to interpose said film between said wires.

### Advantage of the Invention

(1) As described above, in the reactor of claim 1, the coil is encased in a state where the coil is entirely enclosed from the outside by the electrically insulating resin to configure the encased coil body, and the core is configured by the molded body which is formed by injection-molding the mixture including the soft magnetic powder and the thermoplastic resin in the state where the encased coil body is integrally embedded in the inner portion of the core.

According to the reactor of claim 1, since the core can be injection-molded in the state where the coil is protected so as to be encased by the resin covering layer from the outside, it is possible to prevent the soft magnetic powder such as iron powder which is included in the mixture from directly striking the insulating coating of the coil or rubbing the insulating coating at the time of the injection, and accordingly, damage on the insulating coating due to the striking of the soft magnetic powder on the insulating coating of the coil at the time of molding the core can be effectively prevented.

In addition, at the time of injection-molding the core, even though the core which is a molded body is shrunk due to cooling, since the resin covering layer is interposed between the core and the insulating coating of the coil as a protective layer or a buffer layer, stress due to shrinkage of the core can be prevented from directly acting on the insulating coating, and therefore, problem of the damage on the insulating coating due to the shrinkage of the core can be solved.

In addition, since the coil configures the integral molded body (encased coil body) with the resin covering layer, deformation of the coil at the time of injection-molding the core can be favorably prevented.

Moreover, since the coil is encased by the electrically insulating resin covering layer, the voltage resistance characteristics of the coil can be strengthened and increased.

(2) In the reactor of claim 2, the core is configured so that the primary molded body which includes the tubular outer circumferential molded portion contacting the outer circumferential surface of the encased coil body, and the secondary molded body which includes an inner circumferential molded portion contacting the inner circumferential surface of the encased coil body are joined to each other at a boundary surface and are integrated.

According to the reactor of claim 2, the core can be molded while being divided into the primary molded body and the secondary molded body, whereby the core can be molded in the state where the encased coil body is positioned at a desired position in the molding die, and it is possible to mold the core which enclose the encased coil body in the state where the encased coil body is positioned at the desired position.

(3) In the reactor of claim 3, the resin covering layer of the encased coil body is configured of an injection-molded body of an insulating thermoplastic resin.

According to the reactor of claim 3, the resin covering layer of the encased coil body can be formed through a simple molding operation; unlike a formation of the resin covering layer using dipping, the resin covering layer can be formed in a sufficient thickness by once molding operation and in a short time; and high voltage resistance (resistance to dielectric breakdown voltage) characteristics can be applied to the coil.

In the reactor of claim 3, the resin covering layer of the encased coil body is configured such that a molded body which includes an outer circumferential covering portion covering the outer circumferential surface of the coil and another molded body which includes an inner circumferential covering portion covering the inner circumferential surface of the coil are joined to each other and are integrated.

According to the reactor of claim 3, the resin covering layer of the encased coil body can be molded so as to be divided twice. In this case, the resin covering layer can be molded in the state where the coil is positioned so as to be constrained in the molding die, and accordingly, the resin covering layer can be formed in the state where the coil is entirely favorably enclosed.

(4) Incidentally, in general, a wire having a round cross-sectional shape has been used as a coil of the reactor.

However, in a case of the coil in which the wire having a round cross-sectional shape is wound, large intervals between the wires adjacent to one another occur.

The cross-sectional area of the wire requires a predetermined cross-sectional area according to the current which flows through the wire, and the number of turns is determined in order to obtain a predetermined inductance.

As a result, the entire height of the coil is increased, and according to this, the height of the core is also increased, resulting in the increase of the size of the reactor.

Therefore, in order to achieve the miniaturization of the reactor, in general, an edge-wise coil is used in which the rectangular wire having a flat shape is configured so as to be wound in the width direction as a coil.

As shown in FIG. 23, in the case of the edge-wise coil 206, adjacent wires (rectangular wires) can be entirely in a cohesive state, and useless spaces are not generated between wires.

In the figure, a reference numeral 204 indicates the core, and a reference numeral 206 indicates the reactor which includes the edge-wise coil 200 and the core 204.

In this kind of reactor, in order to increase the inductance L, increasing the number of turns of the coil is effective.

Here, the inductance L is expressed by the following Expression (1).

L∝μ×N²×A/l Expression (1)

(wherein,

μ: magnetic permeability of core,

N: number of turns of coil,

A: magnetic path cross-sectional area of core, and

l: magnetic path length of core.)

As seen from FIG. 23, in the reactor 206 in the conventional art, the height of the coil 200 (the height in the coil axial direction) is necessarily increased as long as the number of turns of the coil 200 is increased.

Consequently, the magnetic path length (length of magnetic flux shown by reference numeral 208 in FIG. 23) is lengthened if the height of the coil 200 is increased, and the inductance L is decreased.

Therefore, in order to maintain the inductance L constant, the magnetic path cross-sectional area of the core needs to be increased, as a result, the height size and the size in the radial direction of the reactor 206 are increased, resulting in the increase in the entire size.

Moreover, amount of the core material required according to the increase of the size of the reactor is also increased.

In the case of the reactor, the ratio of material costs among the total costs is high, and therefore, the costs of the reactor are also increased according to the increase of the material costs of the core material.

Moreover, if the size of the rector is increased, the entire loss due to core loss, copper loss (loss of the coil itself), or the like is also increased.

Here, in the reactor of claim 4, the rectangular wire is used as the wire for the coil, the coil is configured in a form in which the plurality of coil blocks are superposed in the same axis in the height direction which is the coil axial direction and/or in the radial direction in a state where the plurality of coil blocks are connected to one another, and the aspect ratio A/B is set in a range of 0.7 to 1.8 in which the height size is taken as A and the width direction size is taken as B in the longitudinal cross-section of the coil.

According to claim 4, as apparent below, it is confirmed that miniaturization and weight saving of the reactor can be effectively achieved and loss thereof can be reduced while high inductance characteristics are maintained.

This is because when the coil is configured according to the present invention, compared to the reactor shown in FIG. 23, the magnetic path can be shortened while the cross-sectional area of the coil wire and the number of turns are equally maintained, as a result, the magnetic path cross-sectional area can be decreased.

FIG. 13(A) is one example of claim 4, in which a flat-wise coil is configured by winding a rectangular wire in the thickness direction, two coil blocks 10-1 and 10-2 are coaxially superposed in two stages up and down in the coil axial direction which is a direction perpendicular to the winding and superposing direction of the wire to thereby configure the coil 10, and the aspect ratio A/B is set within a range of 0.7 to 1.8, where the height size of the coil 10 (size which sums the height size of the coil block 10-1 and the height size of the coil block 10-2) is set to A and the width direction size is set to B.

As apparent from the comparison with FIG. 23, in FIG. 13(A), the magnetic path length which is the length of the magnetic flux 208 can be effectively decreased.

The magnetic path length is a length which averages the entire length of all lines of magnetic force. If the circumference of the longitudinal cross-section in the coil 10 is shortened, the magnetic path length is shortened accordingly.

That is, in the reactor of the present invention in which one example is shown in FIG. 13(A), the magnetic path length can be shortened by shortening the circumference in the longitudinal cross-section of the coil.

According to claim 4, miniaturization of the reactor can be realized, and accompanied with the miniaturization, the weight can be decreased and amount of the core material can be decreased to decrease the required costs of the reactor, and the loss is also effectively decreased accompanied with the miniaturization.

Moreover, in the present invention, the aspect ratio expressed by A/B is preferably in a range of 0.8 to 1.2, and is more preferably in a range of 0.9 to 1.1.

(5) In claim 4, as shown in FIG. 13(B), the flat-wise coil is divided into three coil blocks 10-1, 10-2, and 10-3, and these blocks may be superposed in three stages in up and down directions which are the coil axial direction. Alternatively, as shown in FIG. 13(C), the edge-wise coil is divided into two coil blocks 10-1 and 10-2, and these blocks may be disposed so as to be superposed in two rows in the radial direction.

In addition, more coil blocks may be disposed so as to be superposed in the height direction which is the coil axial direction or the radial direction, thereby configuring the entire coil 10.

However, in the present invention, as shown FIGS. 13(A) and 13(B), it is preferable that the coil blocks of the flat-wise coil which is configured by winding the rectangular wire in the thickness direction of the wire be stacked in a plurality of stages, suitably, in two stages in the height direction to thereby configure the entire coil (claim 5).

(6) Next, in the reactor of claim 6, a powder of pure Fe or a powder of an Fe-based alloy having a composition which contains 0.2 to 9.0 mass % of Si is used as the soft magnetic powder.

The pure Fe has a defect in which the core loss is high, however, the pure Fe is low in cost, is easily handled, and has high magnetic flux density characteristics next to Permendur amoung magnetic materials. Therefore, when the characteristics are regard as important, it is preferable that the powder of the pure Fe be used.

The magnetic flux density of the powder of the Fe-based soft magnetic alloy containing 0.2 to 9.0% of Si is lower than that of the pure Fe according to the increase of Si, but the core loss is less than that of the pure Fe. Therefore, the Fe-based soft magnetic alloy has an advantage in which balance between the magnetic flux density and the core loss can be easily treated.

Particularly, the core loss is the minimum value and the magnetic flux density is relatively high when Si content is 6.5%, which makes the powder to an improved soft magnetic material.

If the Si content exceeds 6.5%, the core loss is increased, but since the magnetic flux density is high up to 9.0%, which is sufficiently practical.

However, when the Si content exceeds 9.0%, the magnetic flux density is decreased and the core loss is increased.

On the other hand, if the Si content is less than 0.2%, the characteristics are substantially the same as those of the pure Fe.

Among the powders of the Fe-based soft magnetic alloy containing Si, in the powder containing 6 to 7% of Si, the balance of the inductance characteristics and heat generation characteristics is improved. Therefore, when this point is regarded as important, it is preferable that the composition containing 6 to 7% of Si be used.

On the other hand, in the powder containing 2 to 3% of Si, the balance of costs and performance such as the inductance characteristics and the heat generation characteristics is improved. Therefore, when this point is regarded as important, it is preferable that the composition containing 2 to 3% of Si be used.

Moreover, one kind or more of Cr, Mn, and Ni may be added to the soft magnetic powder as an arbitrary element if necessary.

However, when Cr is added, it is preferable that the added amount be 5 mass % or less. The reason is because the core loss is more easily decreased.

In addition, it is preferable that total amount of Mn and Ni be 1 mass % or less. The reason is because low coercive force is easily maintained.

(7) Next, in the reactor of claim 7, the inner circumferential portion and the outer circumferential portion of the coil in the core are configured of materials which are different from each other.

When a Fe-based alloy powder of Fe—Si series is used as the soft magnetic powder, according to inclusion of Si in Fe and the increase of the content of Si, magnetostriction is decreased, and the magnetostriction becomes zero when the Si content is 6.5%, and the magnetostriction becomes a minus when the Si content exceeds 6.5% (the magnetostriction becomes a plus if the Si content is 6.5% or less). On the other hand, the core loss is the minimum when the Si content is 6.5%, and the core loss is increased when Si content is either more than or less than that amount.

Accordingly, from the viewpoint of the magnetostriction and core vibration due to the magnetostriction, it is preferable that 6.5% of Si be contained.

In the reactor which uses soft magnetic powder having a composition of Fe-6.5% Si as the soft magnetic powder of the core, the core loss is low and the heat generation at the time of operating is also low. On the other hand, there is a disadvantage that the inductance is not sufficiently high.

On the other hand, if the Si content is decreased to 3%, 2% or the like and approaches the pure Fe, the inductance is increased, but the core loss is increased and the heat generation is also increased.

The temperature raise of the core is increased if the heat generation is increased, and the core reaches high temperature. Consequently, in some cases, portions in which the temperature exceeds the allowable maximum temperature which is set in the inner portion of the core material may be generated.

For example, a reactor which is used in a booster circuit of automobiles is a part which is used for a quite long term, and if the temperature raise is repeated for a long term, the resin as a binder is deteriorated due to thermal history, leading to a decrease in a life span of the part.

Accordingly, an allowable end-point temperature (maximum temperature) is set in the reactor, and it is required that the temperature raise clue to the heat generation of the inner portion is suppressed so as to be less than or equal to the set maximum temperature.

In this point, in the case of the reactor which uses the soft magnetic powder having the composition of Fe-6.5Si series as the soft magnetic powder of the core material, the heat generation in the inner portion of the core material is small, and the end-point temperature can be favorably suppressed so as to be less than or equal to the set maximum temperature.

On the other hand, the inductance characteristics which are originally required as the reactor becomes insufficient.

On other hand, when a material which has a small Si content and is close to the pure Fe is used, the inductance characteristics are sufficient, but the heat generation in the inner portion of the core material is increased, and it is thus difficult to suppress the end-point temperature so as to be less than or equal to the set maximum temperature.

Moreover, at the case of the intermediate case, for example, when a material having a composition of Fe-3Si is used, both of the inductance characteristics and the heat generation characteristics become half-done, which does not satisfy any of the characteristics.

Here, in the reactor of claim 7, the core is divided into the inner circumferential portion and the outer circumferential portion of the coil, and the outer circumferential portion is configured of a core material which uses powder of a low Si material configured of pure Fe or an Fe-based alloy containing 0.2 to 4.0 mass % of Si as the soft magnetic powder, that is, a core material having relatively high inductance and high heat generation, while, the inner circumferential portion is configured of a core material which uses powder of a high Si material configured of an Fe-based alloy containing 1.5 to 9.0 mass % of Si as the soft magnetic powder, in which the Si content is more than that of the soft magnetic powder of the outer circumferential portion of the core material, that is, a core material having relatively low heat generation and low inductance.

The reactor of claim 7 is made based on a finding that the temperature raise due to the heat generation in the inner portion of the core is not equal over the entire core and there are portions having a large temperature raise and portions having a small temperature raise.

Specifically, in the core of the reactor, there are portions to which cooling effects are easily applied and portions to which cooling effects are not easily applied, the cooling effects are easily applied to the outer circumferential portion of the coil, and the cooling effects are not easily applied to the inner circumferential portion.

Actually, the inventors and the like measured the end-point temperature of the inner portion of the core, and it was confirmed that the end-point temperature is low at the outer circumferential portion, and the end-point temperature is high at the inner circumferential portion.

Therefore, in the present invention, in the outer circumferential portion in which the cooling thereof is easily achieved, the core material is configured using a material which has large heat generation while capable of obtaining high inductance, specifically, using a powder with a low Si material configured of a pure Fe or a Fe-based alloy containing 0.2 to 4.0% of Si. On the other hand, in the inner circumferential portion in which the cooling thereof is not easily achieved and dissipation of the heat is difficult, the core material is configured using a powder with a high Si material configured of a Fe-based alloy containing 1.5 to 9.0% of Si.

As a result of configuring the core in this manner, it was confirmed that the reactor could be obtained while achieving both of inductance characteristics and temperature suppression characteristics, which are characteristics conflicting with each other.

(8) Here, it is preferable that the Si content of the high Si material which configures the soft magnetic powder of the inner circumferential portion be 1.5 mass % or more larger than the Si content of the low Si material which configures the soft magnetic powder of the outer circumferential portion (claim 8).

It is more preferable that the former Si content is 2.5% or more larger than the latter, and it is most preferable that the former Si content is 3.5% or more larger than the latter.

(9) Incidentally, in the encased coil body which is configured so as to encase the entire coil in the state of being enclosed from the outside by the electrically insulating resin, if the resin covering layer is formed by dipping method, that is, at the case of a method in which the entire coil is immersed in the liquid of the resin, the coated liquid of the resin is subjected to the later hardening reaction in the state where the entire coil is encased, and the resin covering layer is formed, the thickness of the resin covering layer is necessarily thin such as about 20 μm.

Considering safety factor with respect to insulation performance to other parts, the coil as an electrical component needs voltage resistance characteristics of 5 to 20 times of the rated voltage.

For example, in the case of the reactor which is used for the booster circuit of the hybrid vehicle, high voltage resistance having the voltage resistance of about 3000V is needed. Thereby, the thickness of the resin covering layer needs to be at least 0.1 mm or more. However, the thickness of the resin covering layer which is formed by the dipping method is not sufficient.

Certainly, by repeating the dipping and the later hardening many times, the thickness of the resin covering layer may become thick as 0.1 mm or more. However, in this case, repeating of the dipping and the hardening reaction should be performed many times, and therefore, the processing costs are significantly increased.

On the other hand, in the wire with attached insulating coating which has been conventionally used in general, the insulating coating which is formed so as to adhere over the entire outer surface of the wire is formed by coating the liquid of resin on the outer surface of the wire as described above and hardening the same. However, from the view point of the voltage resistance of the wires adjacent to each other, conversely, there is a problem in that the insulating coating is too thick.

As the wire of the coil for the reactor, conventionally, the rectangular wire has been used. The thickness of the insulating coating which is formed so as to adhere to the outer surface of the wire is 20 μm or more, and normally is 20 to 30 μm.

Accordingly, the entire thickness of the insulating coating which is interposed between wires adjacent to each other in the coil is 40 to 60 μm which is twice of 20 to 30 μm.

However, the electric potential difference between wires adjacent to each other in the coil at most is about dozens of volts, and even considering the safety factor, the voltage resistance is about 100 V to 200 V. With respect to this level of voltage resistance, the insulating coating of 40 to 60 μm has an unnecessary thick thickness.

As a result, under the same number of turns, the outer diameter of the coil is increased and the size of the coil is increased.

In addition, according to the increase of the size of the coil, the entire length of the wire which configures the coil is increased, the required costs of the coil are increased as much, and copper loss from the coil due to direct current-superimposed current in the coil (hereinafter, referred to as “direct current copper loss”) is increased, which generates a problem related to a decrease of the performance of the reactor.

In addition, if the diameter of the coil is increased, the size of the coil is increased, and therefore, the size of the reactor itself is also increased. Consequently, the amount of the core material used is also necessarily increased, which also becomes a factor increasing the costs of the reactor.

In addition, in the conventional rectangular wire with attached insulating coating, due to the restriction accompanied with the method of manufacture thereof, it is difficult to sufficiently increase flatness of the wire, and the flatness is at most about 10. In addition, in order to increase the flatness more than the above, the cost are suddenly increased.

Consequently, since the flatness of the rectangular wire is restricted to a fixed level or less, when the rectangular wire is used at high frequency, the heat generation due to the skin effect is increased.

Therefore, in claim 9, the reactor is configured using a flat-wise coil in which a rectangular wire to which an insulating coating is not attached is wound in the thickness direction of the wire in a state where an insulating film molded in a film shape in advance is interposed between the wires.

According to claim 9, the thickness of the insulating film which is interposed between the wires (rectangular wires) in the coil and insulates these wires can be freely varied by changing the thickness of the film used, and the thickness of the insulating film can be the minimum thickness while the required voltage resistance is secured.

Consequently, the outer diameter of the coil can be decreased to miniaturize the coil, and accordingly, the miniaturization of the reactor can be also realized.

In addition, the length of the wire which configures the coil can be shortened, and therefore, the costs required for the wire can be decreased, the amount of the core material required for the reactor can be decreased, and the costs for the core material can be decreased.

Moreover, the length of the wire can be shortened, and therefore, the direct current copper loss at the time of the operation can be decreased.

In addition, according to the reactor of claim 9, since the coil can be configured using the rectangular wire to which the insulating wire is not attached, a wire which is roll-processed can be used as the wire, and therefore, the required costs for the wire can be decreased. Moreover, the wire having high flatness in which the flatness exceeds 10 can be easily manufactured.

Consequently, since the wire having high flatness can be used, the heat generation of the coil due to the skin effect when the coil is used at high frequency can be effectively suppressed.

Incidentally, when the coil is configured according to claim 9, the end surface in the width direction of the wire is exposed.

Therefore, in claim 9, the entire coil is enclosed from the outside by the insulating resin covering layer, so that the coil is encased. Consequently, sufficient insulation properties can be applied to the coil by the insulating film between the wires and the entire resin covering layer.

In this case, it is preferable that the resin covering layer is configured of the injection molded body of the thermoplastic resin, and that the resin covering layer is configured in a form where the molded body which includes the outer circumferential covering portion covering the outer circumferential surface of the coil and the molded body which includes inner circumferential covering portion covering the inner circumferential surface of the coil are included and those two molded bodies are joined and integrated with each other by injection-molding.

The resin covering layer is configured so as to include the two molded bodies and the two molded bodies are integrated with each other by being joined using the injection-molding. Therefore, the resin covering layer can be easily molded using the injection molding.

In this case, since the resin covering layer can be formed by simple molding operation and the resin covering layer can be formed so as to have a sufficient thickness, high voltage resistance (resistance to dielectric breakdown voltage) characteristics can be imparted to the coil.

(10) In the present invention, utilizing that the core is a molded body using the injection molding, when the core is injection-molded according to claim 10, the container portion of the reactor case and the core can be injection-molded so as to be integrated with each other.

Consequently, after the core is molded, that is, after the reactor is manufactured, a separated step in which the container portion of the reactor case is attached to the core of the reactor can be omitted.

(11) In addition, the reactor of the present invention may be used in an alternating magnetic field of a frequency of 1 to 50 kHz, for example, the reactor of the present invention can be suitably applied to reactors which are used in the booster circuit of the hybrid vehicle, the fuel cell vehicle, the electric vehicle, or photovoltaic power generation (claim 11).

(12) Claim 12 relates to a method of manufacture for the reactor described in claim 1. In the method of manufacturing the reactor, the encased coil body is manufactured by performing the step A which encases the coil using the electrically insulating resin in the state where the coil is enclosed from the outside to mold the encased coil body, and the step B which sets the encased coil body to the molding die and injection-molding the mixture including the soft magnetic powder and the thermoplastic resin in the state where the encased coil body is enclosed, thereby molding the core and integrating the coil in an embedded state in the inner portion of the core.

According to the method of manufacture, the reactor of claim 1 can be favorably manufactured.

In the method of manufacture of claim 12, since the mixture which includes the soft magnetic powder and the thermoplastic resin is injected and the core is molded in the state where the coil is protected so as to be encased by the resin covering layer from the outside, the soft magnetic powder such as iron powder which is included in the mixture at the time of the injection does not directly strike the coil and does not rub the coil. Accordingly, even when the coil is a coil with attached insulating coating (in general, the coil is a coil with attached insulating coating), damage on the insulating coating due to the striking of the soft magnetic powder on the insulating coating of the coil at the time of molding the core can be effectively prevented.

In addition, at the time of molding the core, since the resin covering layer is interposed between the core and the insulating coating of the coil as a protective layer or a buffer layer even though the core which is a molded body is shrunk due to cooling, stress due to shrinkage of the core can be prevented from directly acting on the insulating coating, and therefore, problem of the damage on the insulating coating due to the shrinkage of the core can be also solved.

That is, the damage on the insulating coating of the coil at the time of manufacturing the reactor can be effectively prevented.

Moreover, since the coil configures an integral molded body (encased coil body) with the resin covering layer, deformation of the coil at the time of injection-molding the core can be favorably prevented.

In addition, since the coil is encased by the electrically insulating resin covering layer, the voltage resistance characteristics of the coil can be strengthened and increased.

(13) Next, in the method of manufacture of claim 13, the step B which injection-molds the core is divided into the step B-1 which injection-molds the primary molded body which includes a tubular outer circumferential molded portion of the core contacting the outer circumferential surface of the encased coil body in the shape having the opening for inserting the encased coil body in one end side in the coil axial direction in advance, and the step B-2 which molds the secondary molded body which includes the inner circumferential molded portion contacting the inner circumferential surface of the encased coil body; and in the step B-2, the secondary molded body which includes the inner circumferential molded portion is molded in the state where the encased coil body is fitted to the outer circumferential molded portion of the primary molded body obtained through the step B-1 in the state of being innerly fitted and the outer circumferential molded portion is held so as to be constrained in the radial direction from the outer circumferential side in the secondary molding die for the core, and simultaneously, the secondary molded body, the primary molded body, and the encased coil body are integrated with one another.

According to the method of manufacture of claim 13, the reactor of claim 2 can be favorably manufactured, and the following advantages are obtained at the time of the manufacturing.

Cracks of the core described above mainly occur in the outer circumferential portion which surrounds the coil.

According to the method of manufacture of claim 13, since the outer circumferential portion (outer circumferential molded portion) in the core is independently molded as the primary molded body separated to the coil in advance, problem such as occurrence of cracks in the outer circumferential molded portion due to the coil positioned in the inner side of the core when the core is molded is not generated.

The reason is that, since the primary molded body which includes the outer circumferential molded portion is independently molded separated to the coil in advance, the primary molded body, specifically, the outer circumferential molded portion can be freely shrunk according to the cooling at the time of molding.

On the other hand, the secondary molded body which includes the inner circumferential molded portion contacting the inner circumferential surface of the coil (exactly, the inner circumferential surface of the encased coil body) is molded so as to integrate with the coil in the state where the coil is set to the molding die. However, since the inner circumferential molded portion does not particularly receive the resistance due to the coil when being shrunk in the radial direction, the problem such as occurrence of cracks due the shrinkage does not occur.

That is, according to the method of manufacture of claim 13, problem such as occurrence of cracks of the core due to existence of the coil can be effectively solved.

Moreover, in the method of manufacture of claim 13, the encased coil body is fitted to the outer circumferential molded portion of the primary molded body obtained through the step B-1 in the state of being innerly fitted, and the secondary molded body which includes the inner circumferential molded portion of the core is molded in the state where the outer circumferential molded portion of the primary molded body is held so as to be constrained in the radial direction from the outer circumferential side in the secondary molding die for the core.

At this time, the secondary molded body of the core can be molded in the state where the encased coil body, that is, the coil is held so as to be positioned in the molding die for the core via the primary molded body. Accordingly, at this time, the positional misalignment of the coil from the set position due to the injection pressure and the flow pressure can be prevented, and the molding of the core can be completed in the state where the coil is precisely positioned at the previously-set position and held.

Accordingly, it is possible to favorably prevent the characteristics of the reactor from being subjected to adverse effects due to the positional misalignment of the coil at the time of molding the core.

(14) In this case, in the step B-1 which molds the primary molded body, the bottom portion of the core opposite to the opening is molded along with the outer circumferential molded portion, whereby the primary molded body can be formed in a container shape having a bottom portion in which the encased coil body is housed and held in the inner portion thereof (claim 14).

Consequently, in the state where the encased coil body is housed and held in the recess of the primary molded body having a container shape, they can be set to the secondary molding die for the core and the secondary molded body can be molded, and thus workability of the molding at that time is improved.

Moreover, according to this constitution, when the secondary molded body is molded, the encased coil body can be positioned and held by the primary molded body itself also in the up-and-down direction which is the coil axial direction.

(15) Here, it is preferable that the primary molded body be molded so as to have a height in which the encased coil body is housed over the entire height of a recess of the inner portion (claim 15).

(16) Moreover, in the present invention, in the step B-2 which molds the secondary molded body, the cover portion which closes the opening in the primary molded body may be molded along with the inner circumferential molded portion (claim 16).

(17) Next, in the method of manufacture of claim 17, the encased coil body (exactly, resin covering layer) is molded by injection molding, and the injection molding is performed while dividing the injection molding step A into the step A-1 and the step A-2.

According to this method of manufacture, in the step A-1, the primary molding die for the resin covering layer is brought into contact with the inner circumferential surface or the outer circumferential surface of the coil and the resin material is injected into the primary molding cavity which is formed on the outer circumferential side or the inner circumferential side of the coil in the state where the coil is constrained so as to be positioned in the radial direction, whereby the primary molded body which includes the outer circumferential covering portion or the inner circumferential covering portion in the resin covering layer is molded and is integrated with the coil.

In addition, in the step A-2, after the step A-1, the primary molded body is set to the secondary molding die along with the coil and the resin material is injected into the secondary molding cavity which is formed on the inner circumferential side or the outer circumferential side of the coil, whereby the secondary molded body which includes the inner circumferential covering portion or the outer circumferential covering portion in the resin covering layer is molded and is integrated with the coil and the primary molded body.

According to the method of manufacture of claim 17, the reactor of claim 3 can be favorably manufactured.

At this time, according to the method of manufacture of claim 17, when the encased coil body is injection-molded, since the molding can be performed so as to be divided into two times, the coil molded body, that is, the resin covering layer can be favorably injection-molded in the state where the coil is held so as to be favorably positioned by the molding die, and it is thus possible to favorably prevent the positional misalignment of the coil due to the injection pressure or the flow pressure at the time of the molding, and the resin covering layer can be favorably molded in a coil-encasing state.

In claim 17, in the step which molds the inner circumferential covering portion of the resin covering layer, the upper covering portion by which the upper end surface of the coil positioned at the opening side is entirely covered up to the outer circumferential end can be molded along with the inner circumferential covering portion.

Consequently, when the secondary molded body of the core is injection-molded in the state where the encased coil body is set to the secondary molding die for the core along with the primary molded body of the core, since the joint portion between the primary molded body and the secondary molded body in the resin covering layer is not positioned at the inner circumferential covering portion and the upper covering portion of the resin covering layer on which the injection pressure and the flow pressure strongly act, even if a gap is generated between the primary molded body and the secondary molded body of the resin covering layer in the joint portion (a slight gap may be generated at the joint portion of the primary molded body and the secondary molded body), a problem that the soft magnetic powder strongly infiltrates the gap under a strong injection pressure at the time of the injection-molding of the secondary molded body of the core to thereby damage the insulating coating can be avoided.

(18) In claim 18, a long rectangular wire is wound along with a long film which has been molded to have a width corresponding to the rectangular wire so that the film is interposed between the wires. According to the method of manufacture of claim 18, the coil of claim 9 can be easily and favorably manufactured.

### BRIEF DESCRIPTION OP THE DRAWINGS

FIG. 1 describes views showing a reactor of an embodiment of the present invention.

FIG. 2 is a main body cross-sectional view of the reactor in FIG. 1.

FIG. 3 is a perspective view in which the reactor of FIG. 1 is exploded and illustrated.

FIG. 4 is a perspective view in which the encased coil body of FIG. 2 is exploded into a resin covering layer and a coil, and illustrated.

FIG. 5 describes a view when the coil of FIG. 4 is viewed from an angle other than that of FIG. 4 and a view in which the coil is exploded into an upper and lower coils and illustrated.

FIG. 6 describes explanatory views of a molding procedure of the encased coil body of the embodiment.

FIG. 7 describes an explanatory view of the molding procedure following FIG. 6.

FIG. 8 describes process explanatory views of a method of manufacture for the reactor of the embodiment.

FIG. 9 shows explanatory views of a method of molding the encased coil body in the embodiment.

FIG. 10 shows explanatory views of a method of molding the core in the embodiment.

FIG. 11 describes views showing another embodiment of the present invention.

FIG. 12 describes views showing an example of a method of manufacture for a reactor of the embodiment of FIG. 11.

FIG. 13 describes views showing a disposition example of the coil.

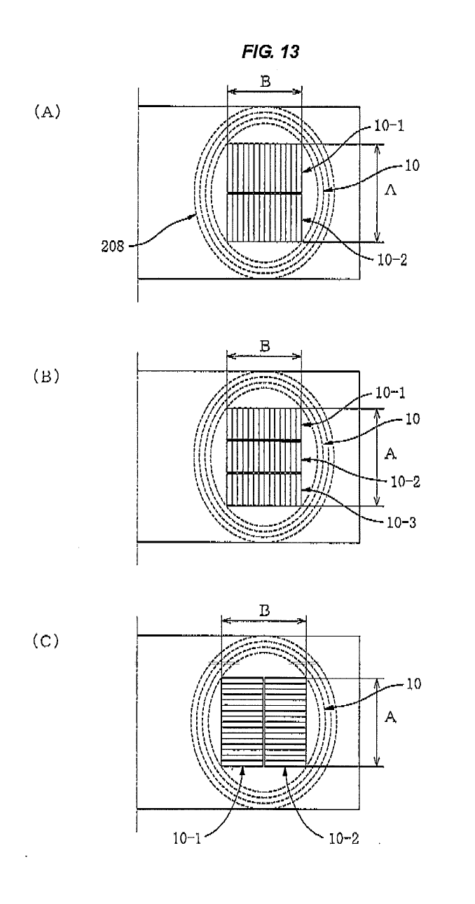

FIG. 14 describes graphs showing a relationship between an aspect ratio of the cross-section of the coil 10 and a weight ratio or a loss ratio.

FIG. 15 is an explanatory view showing a method which divides the core materials when core materials in the reactor are different.

FIG. 16 is an explanatory view showing a test method of estimation of characteristics when compositions of the core material are different.

FIG. 17 is an explanatory view showing positions of temperature measurement points of the core material.

FIG. 18 is an explanatory view of methods of manufacture for an example A-1 and an example A-3 in Table 2.

FIG. 19 is a view showing an example of an aluminum case (reactor case).

FIG. 20 shows views of a main portion of another embodiment.

FIG. 21 is a view schematically showing a background which is problems of the present invention.

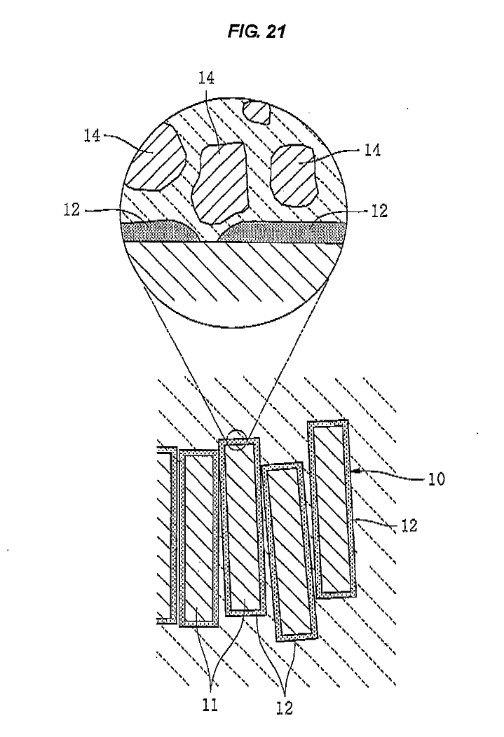

FIG. 22 is a view schematically showing problems other than those of FIG. 21.

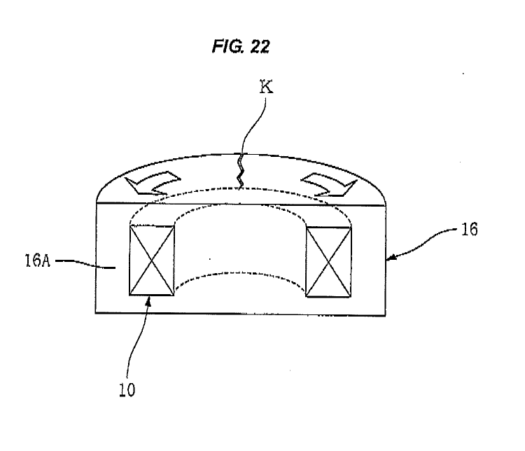

FIG. 23 is a main portion cross-sectional view showing an example of the reactor as explanation of the background of the present invention.

### MODE FOR CARRYING OUT THE INVENTION

### First Embodiment

Next, a configuration, and the like of a reactor which is an embodiment of the present invention will be described below.

(Powder)

The soft magnetic powder may use powder which is formed by an atomization method through gas atomization, water atomization, centrifugal atomization, combination thereof (for example, gas and water atomization), or rapid cooling just after the gas atomization, or the like, a mechanical crush method through a jet mill, a stamp mill, a ball mill, or the like, a chemical reduction, and the like.

From the viewpoint that mechanical energy is not required in the crush in which distortion is relatively decreased, a spherical type is easily formed, dispersibility is improved, or the like, it is preferable that the soft magnetic powder be powder formed by the atomization method. From the view point that the distortion is decreased, oxidation also is decreased, and the like, it is more preferable that the soft magnetic powder be a powder formed by a gas atomization method.

For example, from the viewpoint of yield of the powder at the time of the atomization, mixing torque or firing properties at the time of mixing, flowability at the time of the injection-molding, frequency used, or the like, a particle diameter of the soft magnetic powder is preferably a range of 1 to 500 μm, is more preferably a range of 5 to 250 μm, and is most preferably a range of 10 to 150 μm.

In the powder, effects which reduce eddy current loss are increased as the particle diameter is decreased. However, conversely, hysteresis loss may be increased. Therefore, it is preferable that the upper and lower limits of the particle diameter of the powder, distribution of the particle diameter, and the like are determined according to balance between the yield of the powder (that is, costs) and the obtained effects (that is, core loss), the used frequency, or the like.

In order to remove the distortion or improve coarsening of crystal particles, it is preferable that the soft magnetic powder be subjected to a heat treatment. As conditions of the heat treatment, temperature of 700° C. to 1000° C. and times of 30 minutes to 10 hours under the atmosphere of either or both of hydrogen or argon may be exemplified.

For example, as a thermoplastic resin which configures a core material or a resin covering layer, polyphenylene sulfide (PPS) resin, polyamide (PA) resin such as polyamide 6, polyamide 12, and polyamide 6T, polyester resin, polyethylene (PE) resin, polypropylene (PP) resin, polyacetal (POM) resin, polyether sulfone (PES) resin, polyvinyl chloride (PVC) resin, ethylene-vinyl acetate copolymer (EVA) resin, or the like may be exemplified.

Among these, from the viewpoint of heat resistance, flame resistance, insulation properties, moldability, mechanical strength, or the like, polyphenylene sulfide resin and polyamide resin are suitable.

From the viewpoint of increasing magnetic flux density, setting magnetic permeability to a suitable range, increasing thermal conductivity, or the like, the ratio of the soft magnetic powder in the mixture of the soft magnetic powder and the resin which configure the core material is preferably 30 volume % or more, more preferably 50 volume % or more, and still more preferably 60 volume % or more.

In addition to the soft magnetic powder and the resin, the mixture may include one kind or two or more kinds of various additives such as antioxidant, age resister, ultraviolet absorber, filler, stabilizer, potentiator, coloring agent, or the like if necessary.

The resin in the mixture including the soft magnetic powder becomes a molten state using a kneading machine such as a two-axis kneading machine, and therefore, various compositions may be produced by being subjected to a process such as the kneading.

(Molding Method)

When the core is injection-molded, a method may be used in which kneaded materials in which the soft magnetic powder and the resin have been kneaded in advance are supplied to an injection-molding apparatus, the kneaded materials are plasticized (become a molten state), and the core is molded by injecting the kneaded materials into a die. Moreover, it is also applicable that the soft magnetic powder and the resin such as a powder type are supplied to the injection molding apparatus independently or in a mixed state respectively, the resin is kneaded in a molten state in the apparatus, and the mixture may be injected into the die.

After the soft magnetic mixture is injected into the die, the mixture is cooled for a suitable time, and thus an injection-molded core having a predetermined shape corresponding to the cavity shape of the die may be obtained. Moreover, the obtained injection-molded core may be subjected to processing such as machining if necessary.

As the injection-molding apparatus, a horizontal type injection molding apparatus, a vertical type injection molding apparatus, a plunger type injection molding apparatus, a screw type injection molding apparatus, an electric injection molding apparatus, a hydraulic injection molding apparatus, a two-material injection molding apparatus, an injection-molding apparatus which combines these, or the like may be used.

Next, an embodiment of the reactor and a method of manufacture for the same will be described below with reference to the drawings.

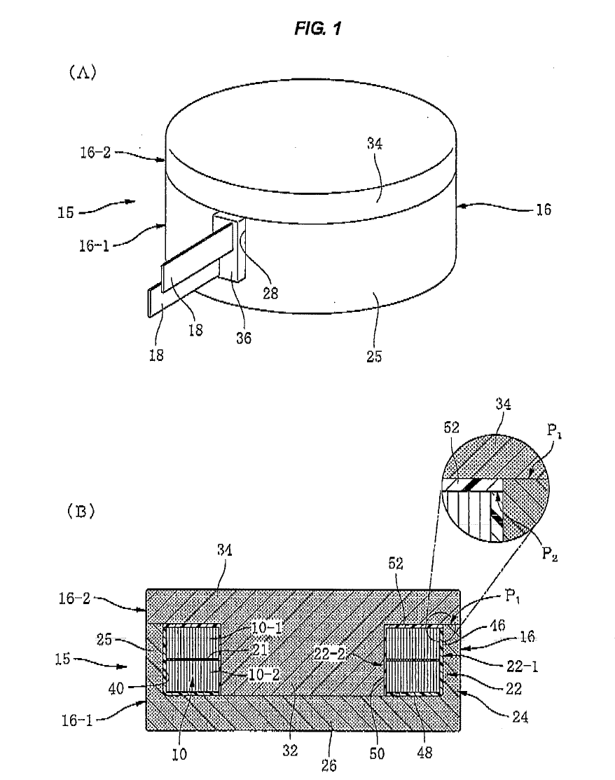

In FIG. 1, a reference numeral 15 is the reactor (choke coil) which is an inductance part, and a coil 10 with attached insulating coating is integrated so as to be an embedded state in the inner portion of a core 16 formed of a soft magnetic resin molded body. That is, the core 16 is manufactured so as to be the reactor having structure with no gap.

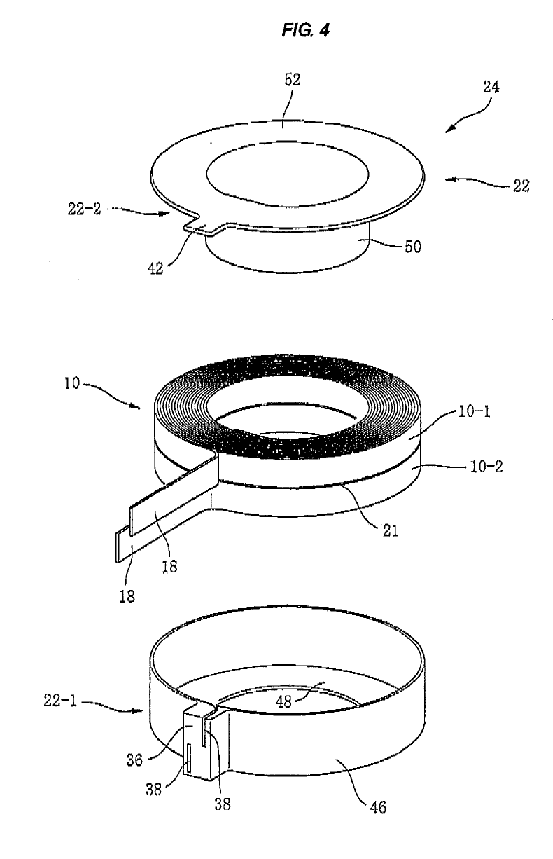

In this embodiment, as shown in FIGS. 4 to 6(A), the coil 10 is a flat-wise coil and is formed in a coil shape by winding and superposing a rectangular wire in the thickness direction (radial direction) of the wire, in which wires adjacent in the radial direction in a state of a free shape which are processed to be wound and are molded to be superposed so as to be a state of being in contact with one another via the insulating coating.

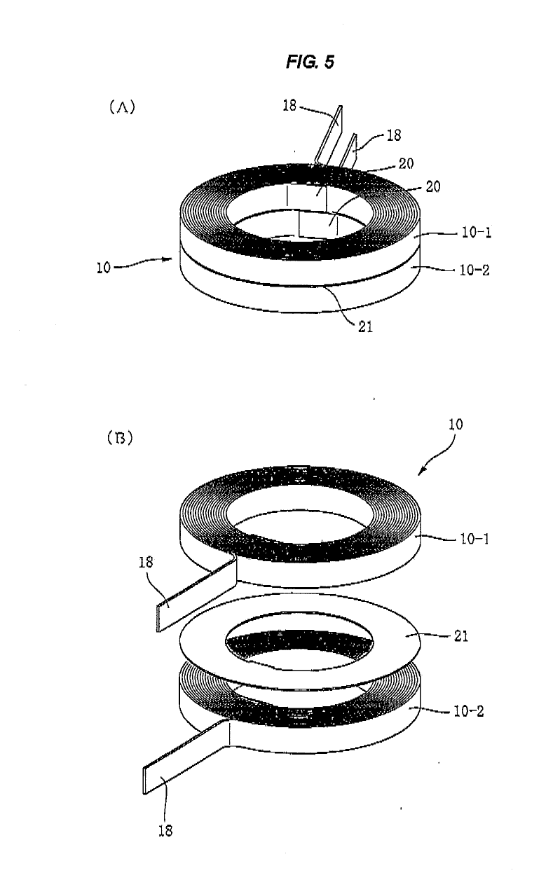

In the present embodiment, as shown in FIGS. 4 and 5, an upper coil block (hereinafter, simply referred to an upper coil) 10-1 and a lower coil block (hereinafter, simply referred to as a lower coil) 10-2 are superposed to each other in up and down directions so that the winding directions are opposite to each other, and ends 20 in each of the inner diameter sides are joined to each other, whereby the coil 10 is configured of a single continuous coil. However, the upper coil 10-1 and the lower coil 10-2 may be configured so as to be continuous by means of a single wire.

In addition, since a large electrical potential difference is generated between the upper coil 10-1 and the lower coil 10-2, as shown in FIG. 5(B), an annular insulating sheet 21 is interposed therebetween. Herein, the thickness of the insulating sheet 21 is approximately 0.5 mm.

Moreover, a reference number 18 in the drawings indicates coil terminals in the coil 10, and the coil terminals are formed so as to protrude outside in the radial direction.

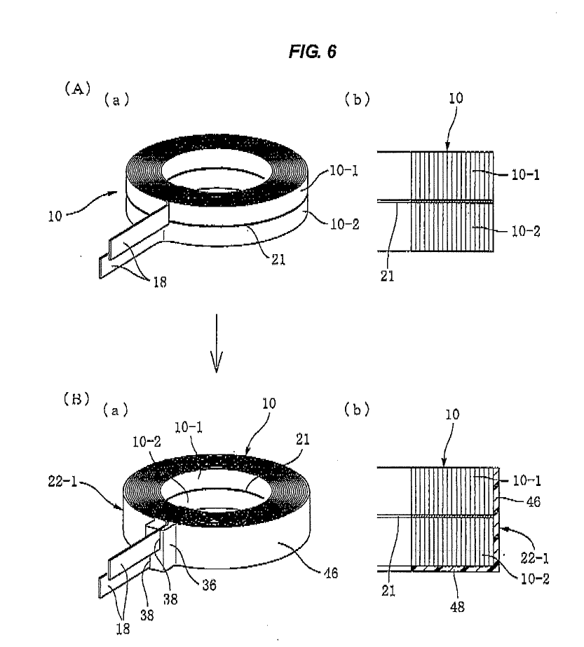

As shown in FIG. 6(A), the upper coil 10-1 and the lower coil 10-2 have the same shape as each other, the planar shapes of both are an annular shape, and therefore, the entire coil 10 also has an annular shape.

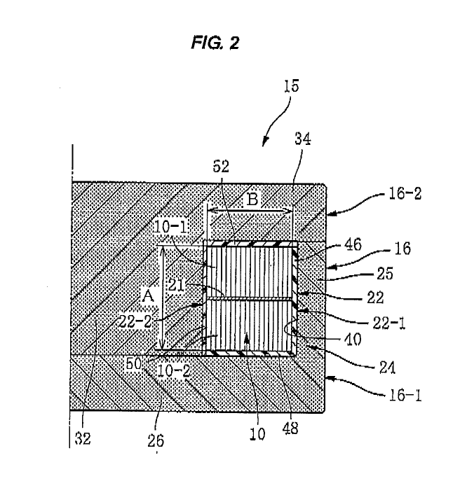

In FIG. 2, a reference numeral A indicates the entire height size in which the two coils are combined. Here, the height size A is a size which includes the insulating sheet 21.

A reference numeral B indicates a width size which is a radial directional size in the longitudinal cross-section and a ratio A/B between the height size A and the width size B in the coil 10 indicates an aspect ratio of the longitudinal cross-section in the coil 10.

Moreover, as shown in FIG. 1, the coil 10 is integrally included in the core 16 in a state of being entirely embedded in the core 16 except for a portion of the tip side of the coil terminal 18.

In this embodiment, various materials such as copper, aluminum, copper alloy, and aluminum alloy may be used for the coil 10 (Incidentally, the coil 10 is made of copper in this embodiment).

In this embodiment, the core 16 is configured of a molded body which is obtained by injection-molding a mixture containing a soft magnetic powder and a thermoplastic resin.

Here, soft magnetic iron powder, sendust powder, ferrite powder, or the like may be used for the soft magnetic powder. Moreover, for example, as the thermoplastic resin, PPS, PA12, PA6, PA6T, POM, PES, PVC, EVA, or the like may be suitably used.

A proportion of the soft magnetic powder that occupies the core 16 may be varied variously, and the ratio is preferably approximately 50 to 70% in terms of volume %.

The coil 10 with attached insulating coating is entirely encased by an electrically insulating resin from the outside except for a portion of the tip side of the coil terminal 18.

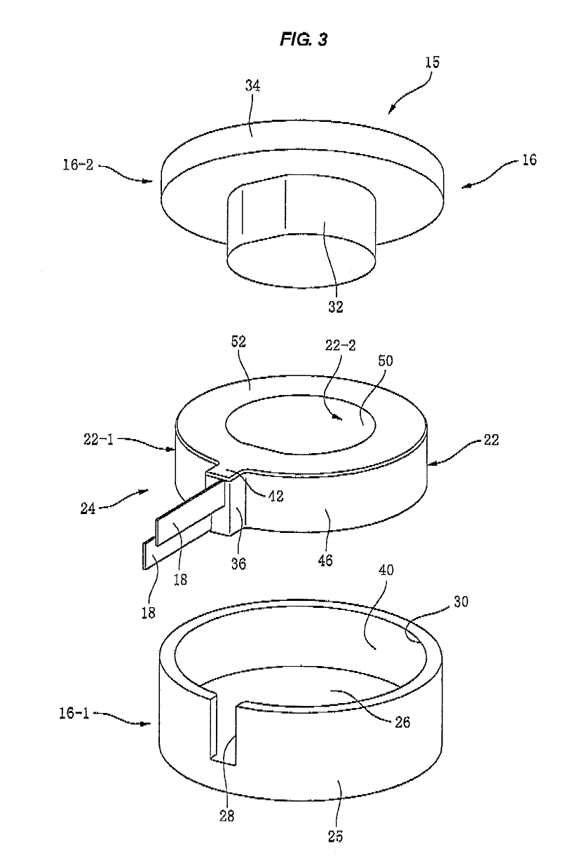

In FIGS. 1 and 3, a reference numeral 24 indicates the encased coil body which is configured of the coil 10 and the resin covering layer 22, in which the coil 10 is embedded in the inner portion of the core 16 as the encased coil body 24. In this embodiment, it is preferable that the thickness of the resin covering layer 22 be 0.5 to 2.0 mm.

The resin covering layer 22 is configured of an electrically insulating thermoplastic resin which does not contain a soft magnetic powder. As the thermoplastic resin, in addition to PPS, PA12, PA6, PA6T, POM, PE, PES, PVC, and EVA, other various materials may be used.

Also as shown in an exploded view of FIG. 3, a primary molded body 16-1 and a secondary molded body 16-2 are joined to each other using an injection-molding at a boundary surface P1 shown in FIG. 1(B), so that the molded bodies are integrated to constitute the core 16.

As shown in FIGS. 1 and 3, the primary molded body 16-1 has a container-like shape that includes a cylindrical outer circumferential molded portion 25 which contacts the outer circumferential surface of the encased coil body 24 and a bottom portion 26 positioned at the lower side of the encased coil 24 in the drawings, in which an opening 30 is present at the upper end in a coil axis line direction in the drawings.

Moreover, a cutout portion 28 is provided on the outer circumferential molded portion 25 of the primary molded body 16-1.

The cutout portion 28 is one for inserting a thick portion 36 (refer to FIG. 3) of the encased coil body 24 described below.

On the other hand, also as shown in FIG. 2, the secondary molded body 16-2 integrally includes an inner circumferential molded portion 32 which contacts the inner circumferential surface of the encased coil body 24, fills a blank space of the inner side of the coil 10, and reaches the bottom portion 26 in the primary molded body 16-1, and an upper circular cover portion 34 which is positioned upward from the encased coil body 24 in the drawings, closes the opening 30 of the primary molded body 16-1, and conceals a recess 40 of the primary molded body 16-1 and the encased coil body 24 accommodated in the recess in the inner portion.

On the other hand, as shown in an exploded view of FIG. 3, the resin covering layer 22 which encases the coil 10 is configured of a primary molded body 22-1 and a secondary molded body 22-2, and they are integrated with each other by joining through an injection-molding at a boundary surface P2 shown in FIG. 1(B).

The primary molded body 22-1 integrally includes a cylindrical outer circumferential covering portion 46 which covers the outer circumferential surface of the coil 10 and a lower covering portion 48 which covers the entire lower end surface of the coil 10.

On the other hand, the secondary molded body 22-2 integrally includes a cylindrical inner circumferential covering portion 50 which covers the inner circumferential surface of the coil 10 and an upper covering portion 52 which covers the entire upper end surface of the coil 10.

Moreover, as shown in FIG. 4, the thick portion 36 which protrudes outward in the radial direction is formed over the entire height in the primary molded body 22-1, and a pair of slits 38 which penetrates the thick portion in the radial direction is formed in the thick portion 36.

The pair of coil terminals 18 in the coil 10 penetrates the silts 38 and protrudes outward in the radial direction of the primary molded body 22-1.

In addition, a tongue-shaped protrusion 42 which protrudes outward in the radial direction is integrally formed with the upper covering portion 52 in the secondary molded body 22-2. The upper surface of the thick portion 36 in the primary molded body 22-1 is covered by the protrusion 42.

In FIGS. 3 to 10, a method of manufacture for the reactor 15 of FIG. 1 is specifically shown.

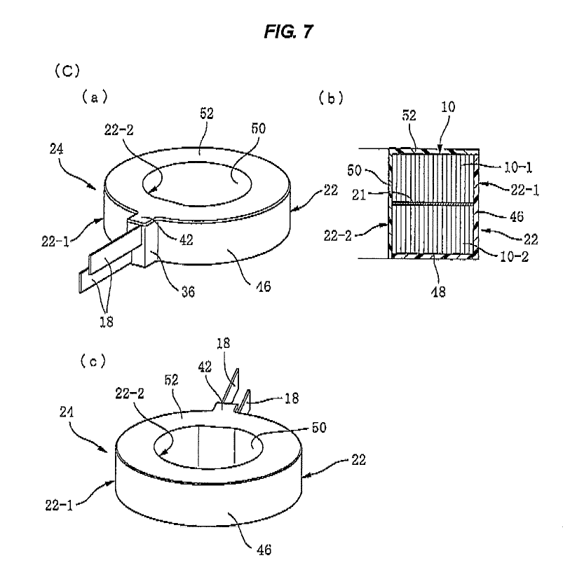

In this embodiment, according to a procedure shown in FIGS. 6 and 7, the resin covering layer 22 is formed so as to enclose the coil 10 with attached insulating coating shown in FIG. 6(A) from the outside, and the encased coil body 24 is configured by integrating the coil 10 and the resin covering layer 22.

Herein, as shown in FIG. 6(B), the primary molded body 22-1 which integrally includes the outer circumferential covering portion 46 and the lower covering portion 48 is firstly molded, and thereafter, as shown in FIG. 7(C), the secondary molded body 22-2 which integrally includes the inner circumferential covering portion 50 and the upper covering portion 52 is molded, whereby the entire resin covering layer 22 is molded.

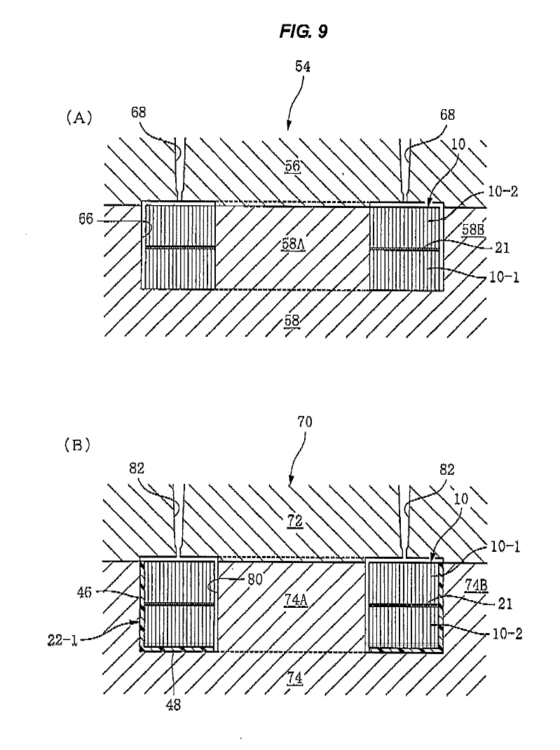

FIG. 9 shows a specific molding method at the time molding the entire resin covering layer.

In FIG. 9(A), a reference numeral 54 indicates a primary molding die for the encased coil body 24, specifically, for the resin covering layer 22, and the primary molding die includes an upper die 56 and a lower die 58.

Here, the lower die 58 includes a middle die portion 58A and an outer die portion 58B.

In a primary molding which uses the primary molding die 54 shown in FIG. 9(A), the coil 10 is firstly set to the primary molding die 54. At this time, the coil 10 is set so that the direction shown in FIG. 4 is turned upside down.

Specifically, the lower coil 10-2 is positioned at the upper side and the upper coil 10-1 is positioned at the lower side, so that the coil is set to the primary molding die 54 so as to be turned upside down.

Moreover, the middle die portion 58A is brought into contact with the inner circumferential surface of the coil 10, whereby the inner circumferential surface of the coil 10 is held so as to be restrained in the radial direction by the middle die portion 58A.

Then, a resin (thermoplastic resin) material is injected into a cavity 66, which is formed on the outer circumferential side of the coil 10 of the primary molding die 54, through a passage 68, and the primary molded body 22-1 of the resin covering layer 22 shown in FIGS. 1 and 6(B) is injection-molded.

Specifically, the primary molded body 22-1, which integrally includes the outer circumferential covering portion 46 and the lower covering portion 48 shown in FIG. 9(B), is injection-molded.

After the primary molded body 22-1 of the resin covering layer 22 is molded in this way, the primary molded body 22-1 is set to a secondary molding die 70 shown in FIG. 9(B) along with the coil 10 which is integrated with the primary molded body 22-1.

At this time, as shown in FIG. 9(B), the coil 10 is set to the secondary molding die 70 so as to be turned upside down along with the primary molded body 22-1.

The secondary molding die 70 includes an upper die 72 and a lower die 74. In addition, the lower die 74 includes a middle die portion 74A and an outer die portion 74B.

In a state where the secondary molding die 70 sets the primary molded body 22-1 along with the coil 10, a cavity 80 is formed on the inner circumferential side and the upper side of the coil.

In the secondary molding using the secondary molding die 70, the same resin material as the resin material at the time of the primary molding is injected into the cavity 80 through a passage 82, and the secondary molded body 22-2 in the resin covering layer 22 is injection-molded, and simultaneously, the secondary molded body is integrated with the primary molded body 22-1 and the coil 10.

In the present embodiment, the encased coil body 24 which is molded as mentioned above is integrated with the core 16 at the time of molding of the core 16 of FIG. 1.

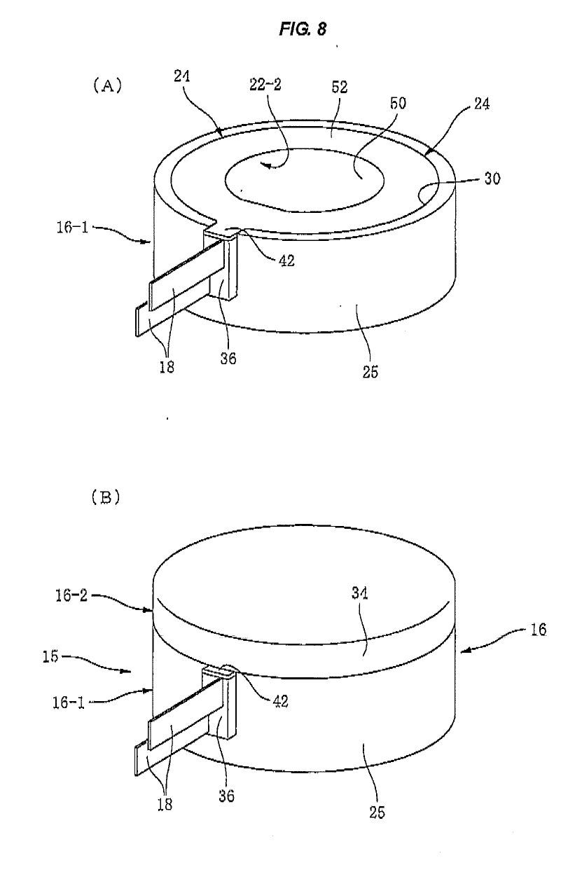

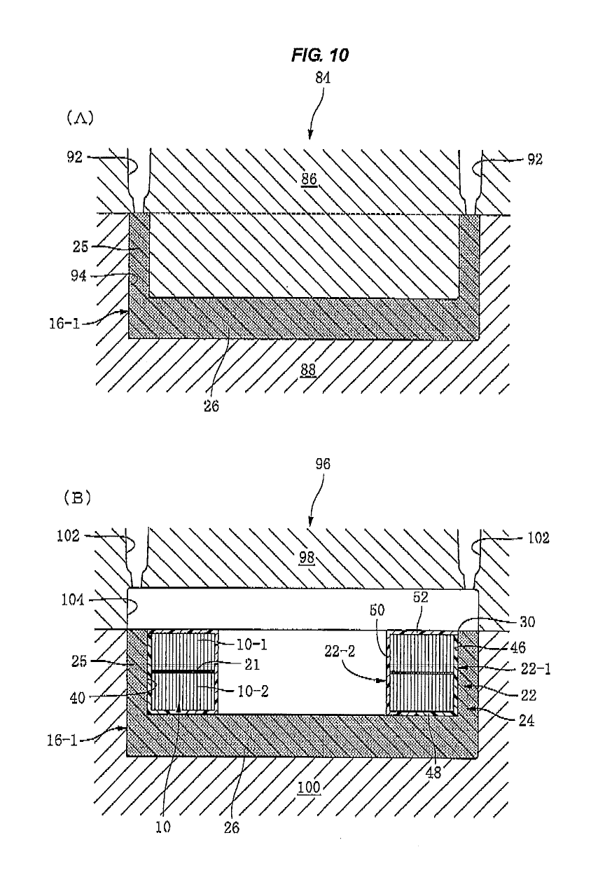

The specific procedures are illustrated in FIGS. 8 and 10.

In this embodiment, when the entire core 16 is molded, as shown in FIG. 8, the primary molded body 16-1 having a container shape is firstly molded in advance.

Thereafter, as shown in FIG. 8(A), the encased coil body 24 molded according to the procedure shown in FIGS. 6 and 7 is inserted into the inner portion of the recess 40 of the primary molded body 16-1 having a container shape over the entire height downward in the drawings through the opening 30 of the primary molded body 16-1, so that the encased coil body 24 is held by the primary molded body 16-1.

Moreover, in that state, the primary molded body 16-1 and the encased coil body 24 are set to the molding die, and the secondary molded body 16-2 in the core 16 is injection-molded so as to be integrated with the primary molded body 16-1 and the encased coil body 24.

FIG. 10(A) shows the primary molding die for the core 16 which molds the primary molded body 16-1.

A reference numeral 84 indicates the primary molding die which molds the primary molded body 16-1 and includes an upper die 86 and a lower die 88.

Here, the mixture of the soft magnetic powder and the thermoplastic resin is injection-molded to a cavity 94 through a passage 92, whereby the primary molded body 16-1 which integrally includes the outer circumferential molded portion 25 and the bottom portion 26 is molded.

FIG. 10(B) shows the secondary molding die which molds the secondary molded body 16-2 in the core 16.

A reference numeral 96 indicates the secondary molding die and includes an upper die 98 and a lower die 100.

In the secondary molding, the encased coil body 24 is firstly inserted into the molded primary molded body 16-1, and in a state of being held, these are set to the secondary molding die 96.

At this time, the outer circumferential surface of the primary molded body 16-1 contacts the entire circumference of the secondary molding die 96, and therefore, the primary molded body 16-1 is positioned in the radial direction. In addition, the lower surface of the bottom portion 26 is held in the state of being positioned in up and down directions in the secondary molding die 96.

That is, the encased coil body 24 is held so as to be positioned not only in the radial direction but also in the up and down directions in the secondary molding die 96 via the primary molded body 16-1.

In the secondary molding, in that state, the same mixture as that used at the time of the primary molding is injected into a cavity 104 through a passage 102 disposed further upward than the cavity 104 in the drawings, whereby the secondary molded body 16-2 of FIGS. 1(B), 3 and, 8(B) is molded, and simultaneously, the secondary molded body 16-2 is integrated with the primary molded body 16-1 and the encased coil body 24.

Here, the reactor 15 shown in FIGS. 1 and 8(B) is obtained.

In the present embodiment as described above, the mixture of the soft magnetic powder and the thermoplastic resin is injected in the state where the coil 10 with the attached insulating coating 12 is encased and protected by the resin covering layer 22 from the outside, whereby the core 16 is molded. Therefore, at the time of the injection, the soft magnetic powder 14 such as iron powder included in the mixture does not directly strongly strikes or rubs the insulating coating 12 of the coil 10, and accordingly, it is possible to effectively prevent the insulating coating 12 from being damaged due to that fact that the soft magnetic powder 14 strikes the insulating coating 12 of the coil 10 at the time of molding of the core 16.

Moreover, since the resin covering layer 22 is interposed between the core 16 and the insulating coating 12 of the coil 10 as a protective layer or a buffer layer, heat stress due to expansion and shrinkage of the core 16 does not directly act on the insulating coating 12, and therefore, the problem of the damage of the insulating coating 12 due to the heat stress can be solved.

In addition, since the coil 10 is integrated with the resin covering layer 22 to form the encased coil body 24, occurrence of the deformation of the coil 10 can be favorably prevented when the core 16 is injection-molded.

Moreover, since the coil 10 is encased by the encasing layer of an electrically insulating resin, voltage resistance characteristics of the coil 10 can be strengthened and enhanced.

In this embodiment, a step for injection-molding the core 16 is divided into a primary molding step in which the primary molded body 16-1 which includes a tubular outer circumferential molded portion 25 contacting the outer circumferential surface of the encased coil body 24 is injection-molded in advance and a secondary molding step in which the secondary molded body 16-2 which includes the inner circumferential molded portion 32 contacting the inner circumferential surface of the encased coil body 24 is molded. In addition, at the secondary molding step, the secondary molded body 16-2 which includes the inner circumferential molded portion 32 is molded in the state where the encased coil body 24 is fitted to the outer circumferential molded portion 25 of the primary molded body 16-1 obtained using the previous injection-molding in the state of being innerly fitted and the outer circumferential molded portion 25 is held so as to be constrained in the radial direction from the outer circumferential side in the secondary molding die 96 for the core, and simultaneously, the secondary molded body is integrated with the primary molded body 16-1 and the encased coil body 24.

That is, in the embodiment, since the outer circumferential molded portion 25 in the core 16 is separately and independently molded with the coil 10 in advance as the primary molded body 16-1, cracks in the outer circumferential molded portion 25 due to the coil 10 which is positioned inside the core 16 at the time of molding of the core 16 do not occur.

Moreover, in the embodiment, since the secondary molded body 16-2 of the core is molded in the state where the encased coil body 24, that is, the coil 10 is positioned and held in the secondary molding die 96 for the core 16 via the primary molded body 16-1, the positional misalignment of the coil 10 from the set position due to the injection pressure and the flow pressure at the time of the molding can be prevented, and the molding of the core 16 can be completed in the state where the coil 10 is precisely positioned at the previously-set position and held.

Accordingly, it is possible to favorably prevent the characteristics of the reactor 15 from being subjected to adverse effects due to the positional misalignment of the coil 10 at the time of molding the core 16.

In addition, since the secondary molded body 16-2 is molded in the state where the encased coil body 24 is housed and held in the recess 40 of the primary molded body 16-1 having a container shape, molding workability is improved, and the encased coil body 24 can be positioned and held also in up and down directions which are the axial direction of the coil in the primary molded body 16-1 itself at the time of molding the secondary molded body 16-2.

In the present embodiment, when the resin covering layer 22 of the encased coil body 24 is injection-molded, since the molding is performed so as to be divided into at least two times, the molding can be performed in the state where the coil 10 is held so as to be favorably positioned by the molding die, and it is thus possible to favorably prevent the positional misalignment or the deformation of the coil 10 due to the injection pressure or the flow pressure at the time of the molding.

In addition, in the present embodiment, when the secondary molded body 16-2 of the core 16 is injection-molded in the state where the encased coil body 24 is set to the secondary molding die 96 for the core along with the primary molded body 16-1 of the core 16, since the joint portion between the primary molded body 22-1 and the secondary molded body 22-2 in the resin covering layer 22 is not positioned at the inner circumferential covering portion 50 and the upper covering portion 52 of the resin covering layer 22 on which the injection pressure and the flow pressure strongly act, a problem that the soft magnetic powder infiltrates the gap of the joint portion under a strong injection pressure to thereby damaging the insulating coating 12 of the coil 10 can be favorably avoided.

### Experiment Example

A coil 10 was used in which the upper coil 10-1 and the lower coil 10-2 (both were a flat-wise coil having an outer diameter of φ80 mm, an inner diameter of φ47 mm, and a number of turns of 18, and one reversed and superimposed with the other) configured by winding a rectangular wire (9 mm in width and 0.85 mm in thickness) with an attached insulating coating (polyamide-imide film of 20 to 30 μm) were joined so as to be superposed up and down and were integrated with each other, a linear-type PPS was used as the thermoplastic resin, and the primary molded body 22-1 of the resin covering layer 22 in the encased coil body 24 was molded.

At this time, in the primary molded body 22-1, the outer circumferential covering portion 46 was molded to have a thickness of 1 mm and the lower covering portion 48 was molded to have a thickness of 1 mm.

Subsequently, the secondary molded body 22-2 was molded using the same PPS resin through the secondary molding die 70 for the resin covering layer 22.

At this time, in the secondary molded body 22-2, the inner circumferential covering portion 50 was molded to have a thickness of 0.5 mm and the upper covering portion 52 was molded to have a thickness of 1 mm.

Moreover, at this time, the molding of the resin covering layer 22 was performed according to the following conditions. The injection-molding was performed with an injection temperature of 320° C., a temperature of the molding die of 130° C., and an injection pressure of 147 MPa.

At the same time, the primary molded body 16-1 was injection-molded in the core 16 using the mixture in which the soft magnetic iron powder and the linear-type PPS were mixed at the combination ratio for making the ratio of the soft magnetic iron powder to 60 volume %, the encased coil body 24 was received into the primary molded body 16-1, in this state, the secondary molded body 16-2 was molded in the core 16 using the same mixture in the separated secondary molding die 96, and simultaneously, the secondary molded body was integrated with the primary molded body 16-1 and the encased coil body 24, whereby the reactor 15 (in the size, the outer diameter of the core 16 was φ90 mm and the height was 40.5 mm) was obtained.

Incidentally, at this time, the molding of the core 16 was performed according to the following conditions. That is, the injection-molding of the core 16 was performed with an injection temperature of 310° C., a temperature of the molding die of 150° C., and an injection pressure of 147 MPa.

Occurrence of cracks was not observed in the core 16 of the reactor 15 which was obtained as described above.

The voltage resistance characteristics of the reactor 15 obtained as described above was measured as follows.

Here, the reactor 15 was directly disposed on an aluminum base plate so that the reactor 15 was electrically connected to the aluminum base plate, one terminal of a measuring device was connected to one coil terminal 18 of the reactor 15 and the other terminal thereof was connected to the aluminum base plate respectively, and in that state, energization was performed, the voltage was gradually increased from alternating current 0 V to 3500 V (volts), and the voltage was held for one second at 3500° C.

At that time, the reactor was acceptable if the flowing current was 10 mA (milliamperes) or less, the reactor was not acceptable if the flowing current was more than 10 mA, and in this manner, the voltage resistance characteristics were determined.

As a result, according to the reactors of the present embodiment, all ten reactors used in the test were acceptable.

On the other hand, in a comparative example in which the injection-molding was performed to the coil 10 in a state where the resin covering layer 22 was not formed with respect to the coil 10 and the core 16 was thus molded, insulation breakdown occurred in all ten reactors used in the test at 200 to 300 V (volts), and all were determined as being not acceptable.

Incidentally, TOS 5051A manufactured by Kikusui Electronics Corporation was used for the measuring device.

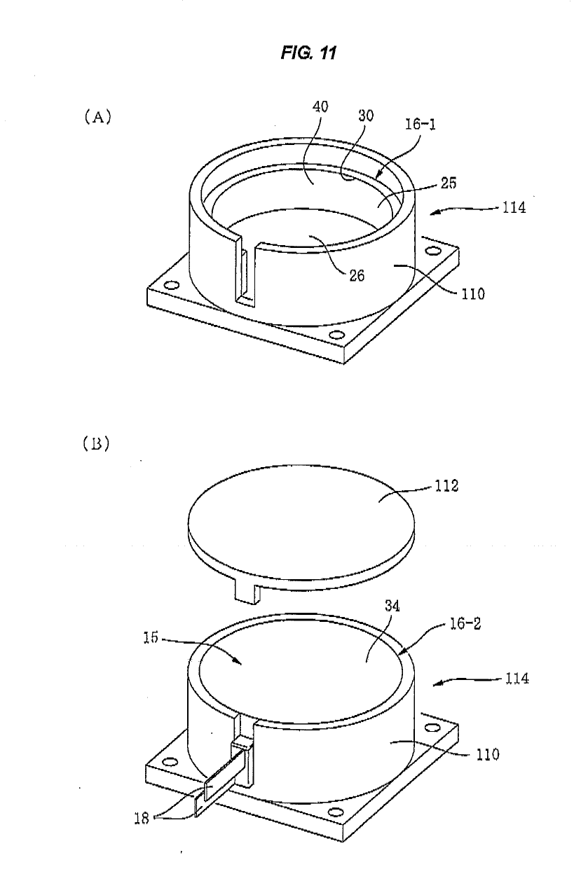

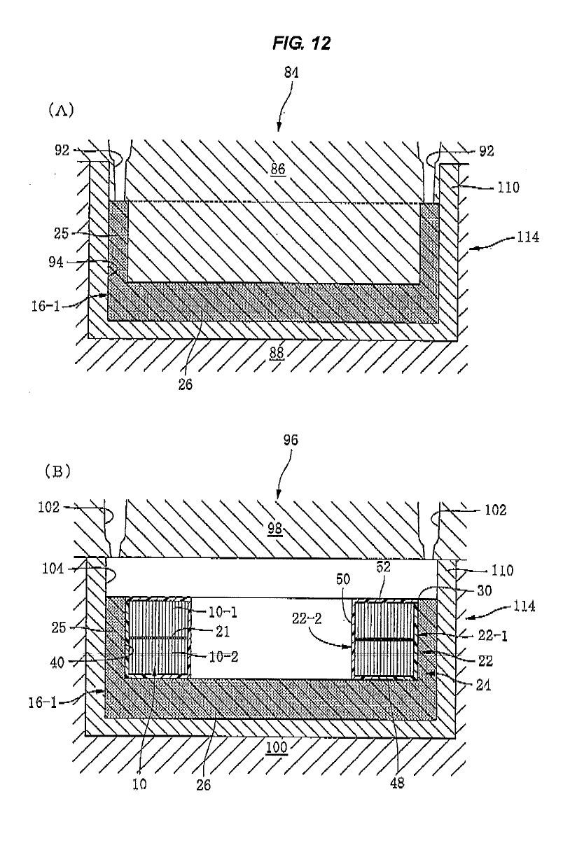

Next, FIGS. 11 and 12 show other example of the reactor and a method of manufacture for the same.

In this example, the core 16 in the reactor 15 is integrally injection-molded with a container portion 110 of an aluminum case (reactor case made of a metal) 114, specifically, the primary molded body 16-1 of the core 16 which includes the bottom portion 26 and the outer circumferential molded portion 25 is integrally injection-molded with the container portion 110.

Here, as shown in FIGS. 11(A) and 12(A), after the container portion 110 of the aluminum case 114 and the primary molded body 16-1 are integrated with each other by the injection-molding, the encased coil body 24 is set in a state of being integrally fitted thereto, thereafter, the secondary molded body 16-2 in the core 16 is injection-molded by the molding method shown in FIG. 12(B) and is integrated with other portions.

Thereafter, the cover portion 112 is covered on the aluminum case (reactor case) 114 as shown in FIG. 11 (B) and the reactor 15 is thus housed in the inner portion of the aluminum case 114.

In this example, using the core 16 being the molded body of the injection molding, when the core 16 is injection-molded, specifically, when the primary molded body 16-1 is molded, the primary molded body 16-1 is integrated with the container portion 110 of the aluminum case 114 made of a metal. Consequently, after the core 16 is molded, that is, after the reactor 15 is manufactured, a step which is a separated step and in which the container portion 110 of the aluminum case 114 is attached to the core 16 of the reactor 15 can be omitted.

### Embodiment 2

The coil 10 in the reactor 15 was configured using a flat-wise coil and an edge-wise coil, without change of the number of total turns and the cross-sectional area of the rectangular wire, effects of weight reduction and loss reduction were examined by variously changing the aspect ratio A/B of the longitudinal cross-section of the coil.

The results are shown in Table 1.

Moreover, Example A in Table 1 is an example which is more preferable than Example B.

This point also is similar in Embodiment 3 and Embodiment 4.

TABLE 1
Embodiment 2

| | | Example | Example | Example | Example | Example | Example | Example | Example | Example | Example |
|---|---|---|---|---|---|---|---|---|---|---|---|
| | | B-1 | B-2 | A-1 | A-2 | A-3 | B-3 | B-4 | A-4 | A-5 | B-5 |
| | | Edge-Wise | Flat-Wise | Edge-Wise | Flat-Wise | Flat-Wise | Flat-Wise | Flat-Wise | Flat-Wise | Edge-Wise | Edge-Wise |
| | | One | One | Two | Two | Two | Two | Two | Three | Two | Two |
| | | Row | Stage | Rows | Stages | Stages | Stages | Stages | Stages | Rows | Rows |
| Core | Size | φ 91 × | φ 117.4 × | φ 102 × | φ 95.2 × | φ 100 × | φ 106 × | φ 113 × | φ 95.5 × | φ 94 × | φ 92 × |
| | (mm) | 50H | 31H | 35.6H | 40.5H | 37.5H | 34.5H | 32.5H | 41 H | 42 H | 46 H |
| | Weight | 1220 | 1320 | 1090 | 1130 | 1160 | 1190 | 1280 | 1150 | 1150 | 1280 |
| | (gram) | | | | | | | | | | |
| Coil | Size | φ 81 × | φ 107.4 × | φ 92 × | φ 85.2 × | φ 90 × | φ 96 × | φ 103 × | φ 85.5 × | φ 84 × | φ 82 × |
| | includ- | φ 60 × | φ 50 × | φ 52 × | 55 × | φ 55 × | φ 53 × | φ 52 × | φ 55 × | φ 56 × | φ 58 × |
| | ing | 29H | 11 H | 15.6 H | 20.5 H | 17.5 H | 14.5 H | 12.5 H | 21 H | 22 H | 26 H |
| | Insulating | | | | | | | | | | |
| | Layer | | | | | | | | | | |
| | (mm) | | | | | | | | | | |
| | Size of | φ 79 × | φ 105.4 × | Inner: | φ 83.2 × | φ 88 × | φ 94 × | φ 101 × | φ 83.5 × | Inner | Inner |
| | Coil | φ 61 × | φ 51 × | φ 90 × | φ 56 × | φ 56 × | φ 54 × | φ 53 × | φ 56 × | φ 82 × | φ 80 × |
| | only | 27H | 9H | φ 72 × | 9H × 2 | 7.5 H × 2 | 6H × 2 | 5 H × 2 | 6H × 2 | φ 70 × | φ 70 × |
| | (mm) | | | 13.6 H | | | | | φ 81 × | 20 H | 24 H |
| | | | | Outer: | | | | | φ 56 × | Outer | Outer |
| | | | | φ 71 × | | | | | 6 H × 1 | φ 69 × | φ 69 × |
| | | | | φ 53 × | | | | | | φ 57 × | φ59 × |
| | | | | 13.6 H | | | | | | 20 H | 24 H |
| | Size | φ 79 × | φ 105.4 × | φ 90 × | φ 83.2 × | φ 88 × | φ 94 × | φ 101 × | φ 83.5 × | φ 82 × | φ 80 × |
| | including | φ 61 × | φ 51 × | φ 53 × | φ 56 × | φ 56 × | φ 54 × | φ 53 × | φ 56 × | φ 57 × | φ 59 × |
| | Insulating | 27H | 9H | 13.6 H | 18.5 H | 15.5 H | 12.5 H | 10.5 H | 19 H | 20 H | 24 H |
| | Sheet | | | | | | | | | | |
| | (mm) | | | | | | | | | | |
| | Weight | 480 | 540 | 480 | 480 | 490 | 500 | 520 | 500 | 470 | 470 |
| | (gram) | | | | | | | | | | |
| | Number | 32 | 32 | 32 | 32 | 32 | 32 | 32 | 32 | 32 | 32 |
| | of Total | | | (16 + 16) | (16 + 16) | (16 + 16) | (16 + 16) | (16 + 16) | (11 + | (16 + 16) | (16 + 16) |
| | Turns | | | | | | | | 10 + 11) | | |
| | Size of | 0.85 × 9 | 0.85 × 9 | 0.85 × 9 | 0.85 × 9 | 0.95 × 7.5 | 1.25 × 6 | 1.5 × 5 | 1.25 × 6 | 1.25 × 6 | 1.5 × 5 |
| | Rectan- | | | | | | | | | | |
| | gular | | | | | | | | | | |
| | Wire (mm) | | | | | | | | | | |
| Induct- | Super- | 350 | 359 | 362 | 372 | 371 | 379 | 378 | 361 | 360 | 359 |
| ance | imposed | | | | | | | | | | |
| (μH) | Current: | | | | | | | | | | |
| | 0 A | | | | | | | | | | |
| | Super- | 180 | 180 | 180 | 180 | 180 | 180 | 180 | 180 | 180 | 180 |
| | imposed | | | | | | | | | | |
| | Current: | | | | | | | | | | |
| | 200 A | | | | | | | | | | |
| A/B | Insulating | 3.0000 | 0.3309 | 0.7351 | 1.3603 | 0.9688 | 0.6250 | 0.4375 | 1.3818 | 1.6000 | 2.2857 |
| | Sheet | | | | | | | | | | |
| | Included | | | | | | | | | | |
| Weight | Core | 100 | 109 | 93 | 93 | 95 | 98 | 105 | 94 | 95 | 100 |
| Ratio | Coil | 100 | 112 | 102 | 99 | 101 | 104 | 108 | 104 | 97 | 97 |
| (%) | Entire | 100 | 109 | 96 | 95 | 97 | 100 | 106 | 97 | 96 | 100 |
| Loss | Iron Loss | 100 | 109 | 93 | 93 | 95 | 98 | 105 | 94 | 95 | 100 |
| Ratio | Copper | 100 | 112 | 102 | 99 | 103 | 109 | 117 | 109 | 102 | 105 |
| (%) | Loss | | | | | | | | | | |
| | (at the | | | | | | | | | | |
| | time of | | | | | | | | | | |
| | Super- | | | | | | | | | | |
| | imposed | | | | | | | | | | |
| | Current: | | | | | | | | | | |
| | 50 A) | | | | | | | | | | |
| | Total Loss | 100 | 110 | 96 | 95 | 97 | 102 | 109 | 99 | 97 | 102 |
| | (at the | | | | | | | | | | |
| | time of | | | | | | | | | | |
| | Super- | | | | | | | | | | |
| | imposed | | | | | | | | | | |
| | Current: | | | | | | | | | | |
| | 50 A) | | | | | | | | | | |

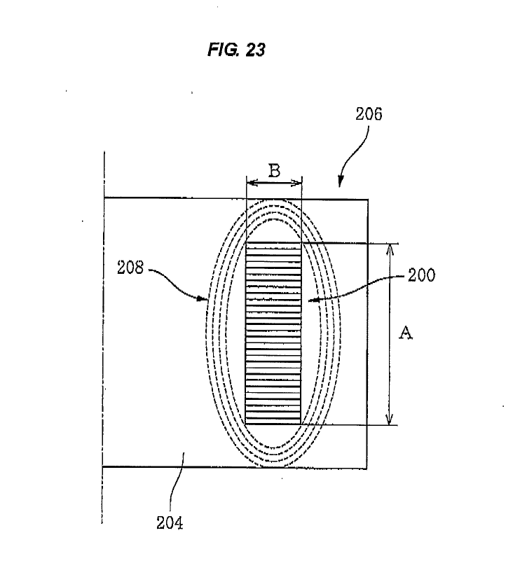

In Table 1, Example B-1 is an example in which the edge-wise coil was used according to a shape shown in FIG. 23, that is, the edge-wise coil was used in a single body according to a shape in which coil blocks were continuous without being superposed to each other, and the reactor of Example B-1 is a reactor of a shape which is conventionally used in general.

Therefore, in Table 1, characteristics such as the weight ratio and the loss ratio of each Example are estimated based on Example B-1 (which is set to 100).

Moreover, Example B-2 is an example in which the flat-wise coil was used in a single body while the coil blocks were not superposed up and down, Example A-1 is an example in which the edge-wise coil was divided into an inner circumferential side coil block and an outer circumferential side coil block, and the coil blocks were disposed in two rows so as to be double superposed in the radial direction so that methods of winding the coil blocks were opposite to each other and were connected to each other at the lower side, and Example A-2 is an example in which the flat-wise coil was divided into an upper coil block and a lower coil block, the coil blocks were disposed so as to be superposed in two stage up and down so that methods of winding the coil blocks were opposite to each other and were connected to each other at the inner circumference.

Similarly, Example A-3, Example B-3, and Example B-4 are an example in which the flat-wise coil was divided into an upper coil block and a lower coil block, the coil blocks were disposed so as to be superposed in two stage up and down so that methods of winding the coil blocks were opposite to each other and were connected to each other at the inner circumference, and are a case where a flatness degree was decreased while the cross-sectional area of the rectangular wire was held so as to be similar to Example A-2. The flatness of degrees of the rectangular wires were 11.25, 8.33, 5.0, and 3.45 in the order of Example A-2, Example A-3, Example B-3, and Example B-4 respectively.

Moreover, Example A-4 is an example in which the flat-wise coil was divided into three coil blocks in up and down directions, the three coil blocks were disposed so as to be step-superposed in three stages up and down so that the winding methods of the upper and lower coils were opposite to that of the middle coil, the lower coil and the middle coil were connected to each other at the inner circumference, and the middle coil and the upper coil were connected to each other at the outer circumference. Example A-5 and Example B-5 are an example in which the edge-wise coil was divided into two coil blocks of the inner circumferential side and the outer circumferential side, the two coil blocks were disposed in two rows in a state of being superposed in the radial direction so that methods of winding the two coil blocks were opposite to each other and were connected to each other at the lower side, and are a case where the flatness degree was decreased while the cross-sectional area of the rectangular wire was held so as to be similar to Example A-1. The flatness of degrees of the rectangular wires are 11.25, 5.0, and 3.45 in the order of Example A-1, Example A-5, and Example B-5 respectively.

(a) Configuration of Reactor

All Examples shown in Table 1 used a soft magnetic powder having a composition of Fe-2Si (mass %) as the soft magnetic powder of the core material.

Moreover, in the case where the coil blocks were disposed so as to be superposed up and down or inside and outside in the radial direction, the insulating sheet having the thickness of 0.5 mm was interposed between the coil blocks.

A value of A/B in Table 1 is a value which includes the insulating sheet.

Moreover, in all Examples, the core material was the soft magnetic powder, the soft magnetic powder was atomized using argon gas and used, and the heat treatment of the powder was performed at 750° C.×3 hours in hydrogen for purposes of oxidation prevention and reduction action. Moreover, assuming that the core material is used in an alternating magnetic field of 1 to 50 kHz, after the soft magnetic powder was subjected to the heat treatment, the soft magnetic powder was sieved by a sieve of 250 μm or less and used.

Next, from the viewpoint for controlling magnetic permeability in a proper range or increasing thermal conductivity and from the viewpoint of flowability in the die, the soft magnetic powder having composition of 65 volume % was mixed with PPS (polyphenylene sulfide) resin. Moreover, the resin was melted at approximately 300° C. by a two-axis kneading machine, and the resin was kneaded with the soft magnetic powder and pelletized.

In addition, the pellet type soft magnetic mixture was heated at approximately 300° C. by a horizontal inline screw type injection molding apparatus and melted, and after the molten mixture was injected into the die, the mixture was cooled and the core material was manufactured.

As the material characteristics of the core material, the initial relative magnetic permeability was approximately 14.6, and magnetic flux density in which magnetism is saturated was approximately 1.3 tesla. Moreover, volume resistivity was 3 to 10×10⁻³ Ω·m, thermal conductivity was 2.0 to 3.5 W/(m·K), and specific heat was 0.6 to 0.65 kJ/(kg·K). In addition, Young' modulus was 20 to 25 GPa, Poisson's ratio was 0.3 to 0.35, and linear expansion coefficient was 2 to 3×10⁻⁵ K⁻¹.

From the viewpoint of electric resistance decrease and skin effect reduction, the coil used a rectangular wire to which a purely copper enamel film (insulating coating) had been attached. From the viewpoint of heat resistance, polyimide-imide was used as the enamel film, and the film thickness was 20 to 30 μm.

The resin covering layer 22 was made of PPS resin for enduring voltage of 3000V or more, the thickness in the inner circumferential side of the coil was 0.5 mm, and the thicknesses of the outer circumferential side, the upper surface side, and the lower surface side of the coil were 1 mm.

Moreover, the axial center of the core and the center in the axial direction thereof were arranged and disposed so as to be coincide the axial center of the coil and the center in the axial direction thereof (This point also is similar to the embodiment 1).

(b) Estimation Method

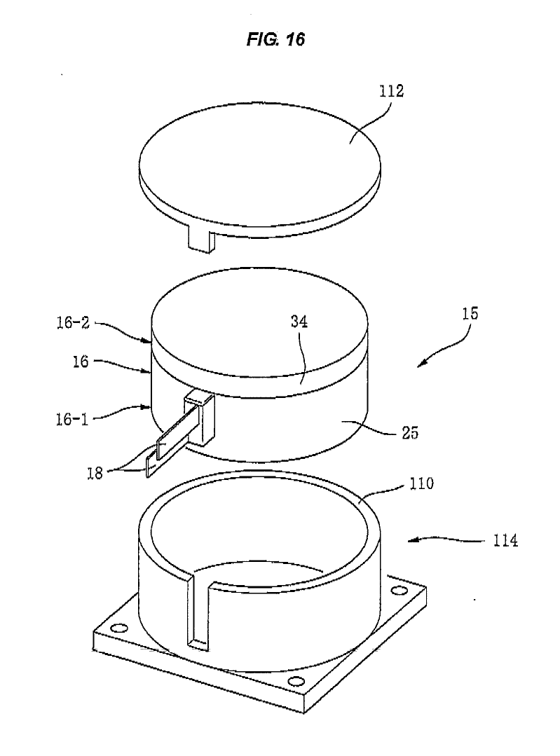

All characteristic estimation was performed in a state where the reactor 15 were housed in the inner portion of the aluminum case (reactor case) 114 which included the container portion 110 and the cover portion 112 shown in FIG. 16.

Here, the thickness of the aluminum case 114 was 5 mm.

Moreover, the fixing between the aluminum case 114 and the reactor was performed by a silicon resin.

(c) Inductance Measurement

In an inductance measurement, the reactor 15 inserted into the aluminum case 114 was incorporated to a voltage boosting chopper circuit, predetermined superimposed current of 300 V of an input voltage, 600 V of a voltage after boosting the voltage, and 10 kHz of switching frequency was flowed, and the circuit was driven. In addition, a waveform of the current (was measured by mounting a clamp-type ammeter on one terminal) which was flowed into the reactor was measured, and the inductance was calculated from an inclination of the current waveform at a certain time interval.

(d) Loss Measurement

A loss measurement was performed according to the following method.

The reactor 15 inserted into the aluminum case 114 was fixed on a water-cooled plate. At this time, heat conduction grease was thinly coated between the water-cooled plate and the aluminum case 114.

At the conditions of 0 A and 50 A of the superimposed current, 300 V→600V, and 10 kHz, the reactor was driven by the voltage boosting chopper circuit similar to the inductance measurement, and the reactor was continuously driven up to a thermal steady state (a state where the internal temperature of the core or the cooling water temperature are not changed in terms of time). Moreover, the cooling water was controlled so as to be flowed into the chiller (constant temperature water cycle device) at 50° C. and 10 liters per minute.

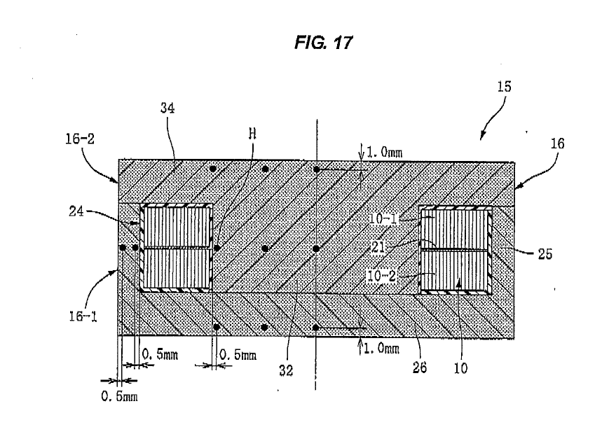

At this time, the internal temperature of the core was measured at several points, and the highest temperature was set to the internal temperature. The measurement places of the temperature were set to eleven points of FIG. 17, thermocouples were embedded thereto, and the temperature was measured. However, in order to avoid effects of the embedding of the adjacent points, the thermocouples were not embedded into the same cross-section and the eleven measurement points were disposed so as to be slightly off-set in the circumferential direction.

At this time, amount of heat was measured from flow rate of the cooling water of the water-cooled plate and the temperature differences of the inlet side and the outlet side, the value of the superimposed current 0 A was set to iron loss, the value of the superimposed current 50 A was set to total loss, and the total loss-iron loss was set to copper loss of the superimposed current 50 A.

Here, it is considered that heat of the coil is almost not generated at the superimposed current 0 A and the copper loss is 0. Therefore, the total loss the iron loss is satisfied at the superimposed current 0 A. Moreover, it is considered that the iron loss is constant independent to the superimposed current. Therefore, if the iron loss is subtracted from the total loss in the superimposed current 50 A, the remaining is the copper loss at the superimposed current 50 A. However, it is assumed that the heat generation of the coil due to current amplitude which excludes the direct current-superimposed current from the current flowed in the reactor is small.

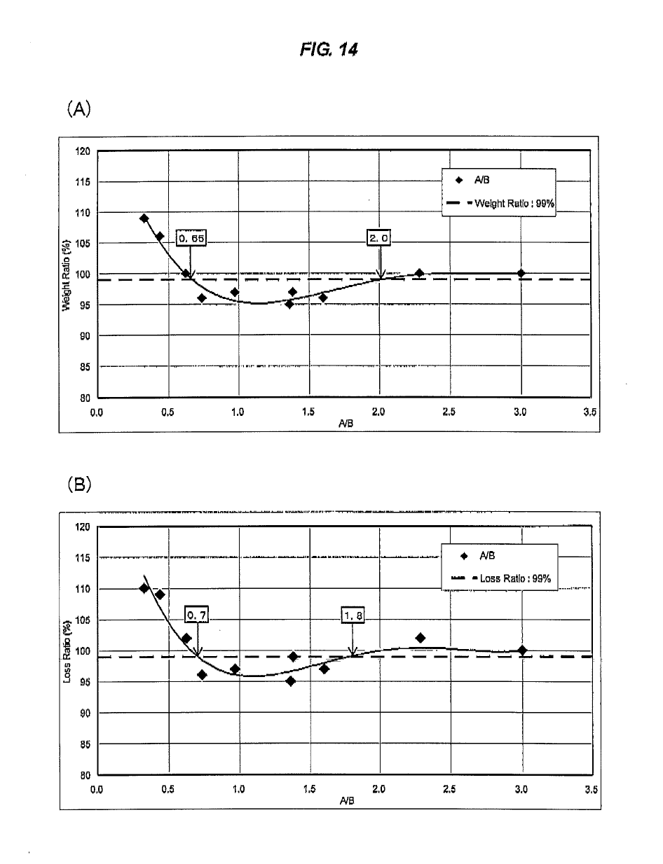

The weight ratio and the loss ratio of each Example based on Example B-1 of Table 1 are shown in FIG. 14.

In FIG. 14, the horizontal axis indicates the aspect ratio A/B, and the vertical axis indicates the weight ratio (FIG. 14(A)) and the loss ratio (FIG. 14(B)).

From FIGS. 14(A) and (B), since the aspect ratio A/B of the coil of the longitudinal cross-section is within the range (Examples A-1 to A-5) of 0.7 to 1.8, it is understood that the weight ratio and the loss ratio can be decreased to 99% or less with respect to Example B-1 while maintaining the inductance almost the same as that of Example B-1.

It is considered that the reason why the tendencies of the weight ratio and the loss ratio with respect to A/B are slightly different to each other is because of the effect in which the loss due to the skin effect is different according to the difference of the flatness degree of the rectangular wire. More specifically, since the copper loss due to influences of the skin effect is increased if the flatness degree is decreased, the loss is greatly changed due to the change of the weight of the coil. Because of this, the range of A/B in FIG. 14(A) is 0.65 to 2.0 and the range of A/B in FIG. 14(B) is 0.7 to 1.8.

In addition, a ratio between the core diameter of the inner circumferential portion of the coil and the circumference of the longitudinal cross-section of the coil (the core diameter of the inner circumferential portion of the coil/the circumference of the longitudinal cross-section of the coil) is 0.81 in Example A-1, 0.86 in Example A-2, 0.87 in Example A-3, 0.84 in Example A-4, and 0.86 in Example A-5.

It is preferable that the ratio between the core diameter of the inner circumferential portion of the coil and the circumference of the longitudinal cross-section of the coil be 0.8 or more.

### Embodiment 3

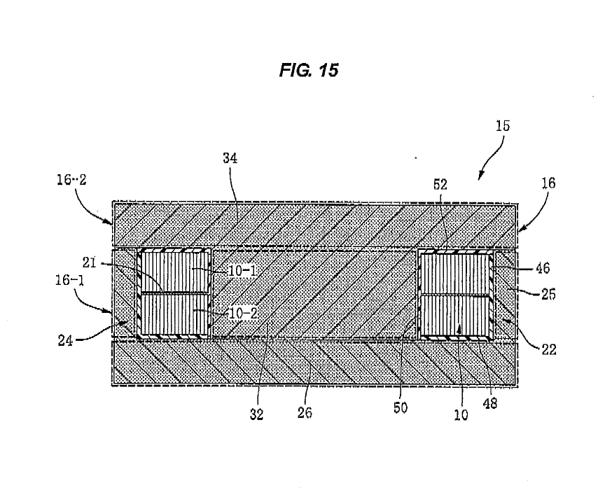

As shown in FIG. 15, in the reactor 15, the outer circumferential molded portion (outer circumferential portion) 25, the inner circumferential molded portion (inner circumferential portion) 32, the bottom portion (lower surface portion) 26, and the cover portion (upper surface portion) 34 of the core 16 were configured of a core material which used the soft magnetic powder having compositions shown in Table 2 and Table 3, and the inductance measurement and the maximum temperature measurement were performed for each of them.

Here, with respect to Examples B-1 to B-9 and Examples A-1 to A-4, the reactor 15 was manufactured according to the method of manufacture shown in FIGS. 1 to 10.

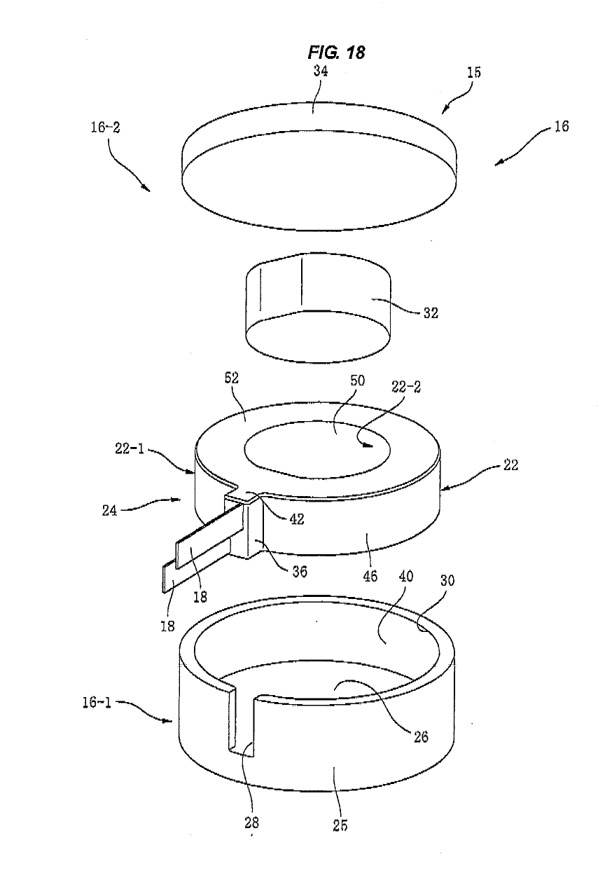

On the other hand, with respect to Example A-5, the reactor 15 was manufactured according to the method of manufacture shown in FIG. 18.

That is, with respect to Example A-5, the primary molded body 16-1 including the bottom portion 26 and the outer circumferential molded portion 25 was independently molded in advance, the same one as the inner circumferential molded portion 32 in the secondary molded body 16-2 of FIG. 3 was independently molded in advance, the encased coil body 24 was fitted into the primary molded body 16-1 in the state of being innerly inserted, the inner circumferential molded portion 32 independently molded in advance was set inside the encased coil body 24 in a state of being innerly inserted, these were set in the molding die in the state of being combined, the cover portion 34 in the secondary molded body 16-2 of FIG. 3 was injection-molded, simultaneously, the cover portion 34 was integrated with the primary molded body 16-1, the encased coil body 24, and the inner circumferential molded portion 32, and therefore, the reactor 15 was manufactured.

On the other hand, with respect to A-6, the outer circumferential molded portion 25 and the bottom portion 26 in the primary molded body 16-1 were independently and separately molded respectively, and the other secondary molded body 16-2, specifically, the inner circumferential molded portion 32 and the cover portion 34 were molded according to the method shown in FIGS. 1 to 10.

(a) Configuration of Reactor

Here, the configuration of the manufactured reactor 15 is as follows.

The soft magnetic powder in the core material of all Examples used gas atomized powder, the gas atomized powder having the composition of 60 volume % mixed with PPS (polyphenylene sulfide) resin, and the soft magnetic powder was configured.

The coil 10 used a pure copper rectangular wire (the thickness was 0.85 mm and the width was 9 mm in the wire size) with attached insulating coating (the film thickness was 20 to 30 μm) which was configured of polyamide-imide, the upper coil 10-1 and the lower coil 10-2, in which the rectangular wire was wound by the flat-wise winding, were superposed in two stages up and down, the inner circumferential side ends 20 were connected to each other, and the ends were insulation-processed again.

As shown in FIG. 5(B), in the superposing method of the upper coil 10-1 and the lower coil 10-2, the upper coil 10-1 was inverted with respect to the lower coil 10-2 and superimposed, and therefore, the current at the time of energization was flowed in the same rotation direction.

In the size of the coil, the inner diameter of the coil was φ47 mm, the number of turns in the upper coil 10-1 and the lower coil 10-2 was 18, and total turns were 36.

The insulating sheet 21 having the thickness of 0.5 mm was interposed between the upper coil 10-1 and the lower coil 10-2.

The core 16 was configured so as to include the coil 10 to be embedded in the inner portion without the interval, and in the size of the core, the outer diameter of the core was φ90 mm and the height of the core was 40.5 mm.

The axial center of the core 16 and the axial center of the coil 10, and the center in the axial direction of the core 16 and the center in the axial direction of the coil 10 were arranged and disposed so as to coincide to each other respectively.

As material characteristics of the core material, the initial relative magnetic permeability was about 13.8 when the soft magnetic powder was pure Fe, was about 13.5 when the powder was 2% Si, was about 13.0 when the powder was 3% Si, was about 12.6 when the powder was 4% Si, was about 12.0 when the powder was 5% Si, and was about 11.1 when the powder was 6.5% Si. The flux density in which the magnetism was saturated was about 1.3 tesla at pure Fe, was about 1.2 tesla at 2% Si, was about 1.17 tesla at 3% Si, was about 1.14 tesla at 4% Si, was about 1.09 tesla at 5% Si, and was about 1.02 tesla at 6.5% Si. Moreover, also in the core materials of all compositions, the volume resistivity was 3 to 10×10⁻³ Ω·m, the thermal conductivity was 2.0 to 3.5 W/(m·K), and the specific heat was 0.6 to 0.65 kJ/(kg·K). In addition, Young's modulus was 20 to 25 GPa, Poisson's ratio was 0.3 to 0.35, and the linear expansion coefficient 2 to 3×10⁻⁵ K⁻¹.

(b-1) Inductance Measurement

The inductance measurement was performed according to the method similar to that described in Embodiment 2.

(b-2) Maximum Temperature Measurement

(b-2-1) Maximum Temperature Measurement at the Time of Water Cooling

The maximum temperature measurement at the time of water cooling was performed as follows.

The reactor inserted into the aluminum case 114 of FIG. 16 was fixed on the water-cooled plate. At this time, heat conduction grease was thinly coated between the water-cooled plate and the aluminum case 114.

At the conditions of 50 A of the superimposed current, 300 V→600V, and 10 kHz, the reactor was driven by the voltage boosting chopper circuit similar to the inductance measurement, and the reactor was continuously driven up to a thermal steady state (a state where the internal temperature of the core or the cooling water temperature is not changed in terms of time). Moreover, the cooling water was controlled so as to be flowed into the chiller (constant temperature water cycle device) at 50° C. and 10 liters per minute. At this time, the internal temperature of the reactor was measured at several points, and the highest temperature was set to the maximum temperature. The measurement places of the temperature were set to eleven points of FIG. 17, thermocouples were embedded thereto, and the temperature was measured. However, in order to avoid effects of the embedding of the adjacent points, the thermocouples were not embedded into the same cross-section and the eleven measurement points were disposed so as to be slightly off-set in the circumferential direction.

In the measurement results, the temperature in the position of a point H of FIG. 17 was highest.

Moreover, from the viewpoint of the difference between the condition which was actually used and the present estimation method, and heatproof temperature and lifespan of the used member, allowable temperature was set to 115° C.

These results are shown in Table 2.

TABLE 2
[Embodiment 3]
MaximumTemperature of Water Cooling

| | | | Maximum |
|---|---|---|---|
| | | | Temperature at the |
| | | Inductance | Time of Water |
| | Soft Magnetic Powder | (μ H) | Cooling (° C.) |
| Mark | | 290 or more | 115 or less |
| Example B-1 | Fe—6.5Si Single Body | 280 (X) | 107 (O) |
| Example B-2 | Fe—5Si Single Body | 289 (X) | 116 (X) |
| Example B-3 | Fe—4Si Single Body | 295 (O) | 119 (X) |
| Example B-4 | Fe—3Si Single Body | 299 (O) | 122 (X) |
| Example B-5 | Fe—2Si Single Body | 303 (O) | 125 (X) |
| Example B-6 | Pure Fe Single Body | 306 (O) | 130 (X) |
| Example A-1 | Inner Circumferential Side of Coil and | 296 (O) | 114 (O) |
| | Upper Surface: Fe—6.5Si | | |
| | Outer Circumferential Side of Coil and | | |
| | Lower Surface: Pure Fe | | |
| Example A-2 | Inner Circumferential Side of Coil and | 294 (O) | 112 (O) |
| | Upper Surface: Fe—6.5Si | | |
| | Outer Circumferential Side of Coil and | | |
| | Lower Surface: Fe—2Si | | |
| Example A-3 | Inner Circumferential Side of Coil and | 292 (O) | 110 (O) |
| | Upper Surface: Fe—6.5Si | | |
| | Outer Circumferential Side of Coil and | | |
| | Lower Surface; Fe—3Si | | |
| Example A-4 | Inner Circumferential Side of Coil and | 290 (O) | 109 (O) |
| | Upper Surface: Fe—6.5Si | | |
| | Outer Circumferential Side of Coil and | | |
| | Lower Surface; Fe—4Si | | |
| Example B-7 | Inner Circumferential Side of Coil and | | |
| | Upper Surface: Fe—6.5Si | | |
| | Outer Circumferential Side of Coil and | 288 (X) | 108 (O) |
| | Lower Surface: Fe—5Si | | |

(b-2-2) Maximum Temperature Measurement at the Time of Air Cooling

The maximum temperature measurement at the time of air cooling was performed as follows.

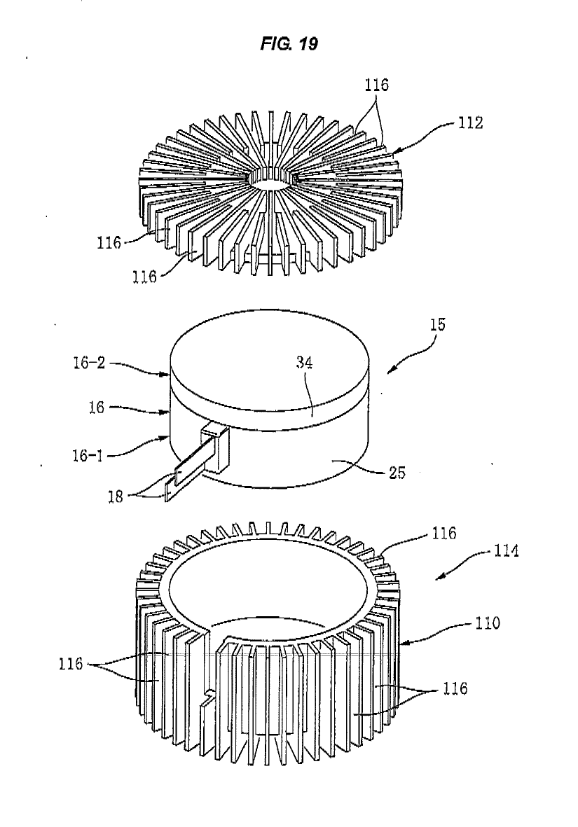

The reactor 15 was accommodated into an aluminum case 114 having attached fins 116 shown in FIG. 19, and an air cooling fan was fixed at the position of 20 mm so that cooling air was flowed from the upper surface and the lower surface toward the aluminum case 114 having the attached fins 116. At this time, ambient temperature is held to 30° C.

The flow rate for one fan is 3000 liters per minute.

At the conditions of 30 A of the superimposed current, 300 V→600V, and 10 kHz, the reactor was driven by the voltage boosting chopper circuit similar to the inductance measurement, and the reactor was continuously driven up to a thermal steady state (a state where the internal temperature of the core or the cooling water temperature are not changed in terms of time).

At this time, the internal temperature of the reactor was measured at several points, and the highest temperature was set to the maximum temperature. The measurement places of the temperature were set to eleven points of FIG. 17, thermocouples were embedded thereto, and the temperature was measured. However, in order to avoid effects of the embedding of the adjacent points, the thermocouples were not embedded into the same cross-section and the eleven measurement points were disposed so as to be slightly off-set in the circumferential direction.

In the measurement results, the temperature in the position of a point H of FIG. 17 was highest.

Moreover, from the viewpoint of the difference between the condition which was actually used and the present estimation method, and heatproof temperature and lifespan of the used member, the allowable temperature was set to 130° C.

The results are shown in Table 3.

TABLE 3
[(Embodiment 3]
Maximum Temperature of Water Cooling

| | | | Maximum |
|---|---|---|---|
| | | | Temperature |
| | | | at the Time |
| | | | of Water |
| | | Inductance | Cooling |
| | Soft Magnetic Powder | (μH) | (° C.) |
| Mark | | 290 or more | 130 or less |
| Example B-8 | Fe 6.5 Si Single Body | 280 (X) | 125 (O) |
| Example B-9 | Pure Fe Single Body | 306 (O) | 154 (X) |
| Example A-5 | Inner Circumferential | 302 (O) | 129 (O) |
| | Side of Coil: Fe—6.5Si | | |
| | Outer Circumferential | | |
| | Side of Coil and | | |
| | Upper and Lower | | |
| | Surfaces: Pure Fe | | |
| Example A-6 | Inner Circumferential | 290 (O) | 126 (O) |
| | Side of Coil and | | |
| | Upper and Lower | | |
| | Surfaces: Fe—6.5Si | | |
| | Outer Circumferential Side | | |
| | of Coil: Pure Fe | | |

From the results of Table 2 and Table 3, the material of each portion of the core 16 in the reactor 15 is configured according to claim 7, and thereby, it is understood that characteristics of each of the inductance and maximum reaching temperature are together satisfied.

In addition, in Table 2 and Table 3, conveniently, the bottom portion 26 is the lower surface portion in the primary molded body 16-1 and the cover portion 34 is the upper surface portion in the secondary molded body 16-2. However, it is assumed that the reactor 15 is installed so as to be reverse up and down with the drawings at the time of the installation, and in the case, the cover portion 34 becomes the lower surface portion and the bottom portion 26 becomes the upper surface portion.

Accordingly, at the case, the bottom portion 26 is the upper surface portion, the cover portion 34 is the lower surface portion, and the bottom portion and the cover portion are configured of the materials shown in Table 2 and Table 3.

### Embodiment 4

Next, still another embodiment of the reactor and the method of manufacture thereof will be described.

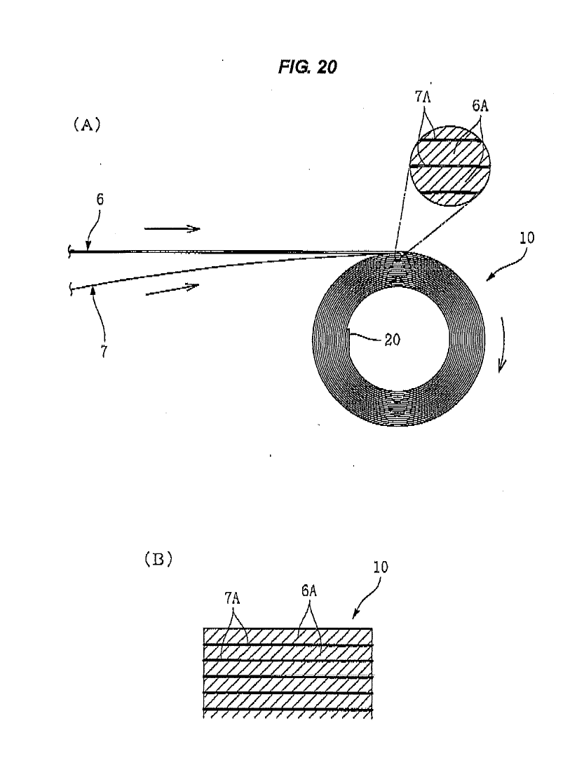

In this Example, the coil 10 is a flat-wise coil which is formed in a coil shape by winding the rectangular wire of a metal single body to which the insulating coating is not attached in the thickness direction (radial direction) of the wire, and an insulating film 7A of resin is interposed between the wire 6A and the wire 6A adjacent to each other as shown in FIG. 20(B). Here, the insulating film 7A has the same width as the wire 6A.

The coil 10 may be manufactured as follows.

In FIG. 20(A), a reference numeral 6 indicates a long wire of a metal single body which is configured of a rolled material, and a reference numeral 7 indicates a long resin film having insulation property, which is molded in a film shape with the same width as the wire 6 in advance in order to form the insulating film 7A between the wire 6A and the wire 6A of FIG. 20(B).

In the method of manufacture for the coil 10 of this example, when the wire 6 of the long metal single body is wound according to a flat-wise winding, the long wire 6 is wound in the thickness direction together in the state where the resin film 7 is interposed.

Thereby, as shown in FIG. 20(B), the insulating film 7A configured of the resin film 7 is interposed between the wires 6A and 6A.

In this example, the thickness of the insulating film 7A is determined according to the thickness of the used film, and accordingly, since films having various kinds of thickness are used as the film, the thickness of the insulating film can be freely different.

Thereby, the thickness of the insulating film can be thin, the outer diameter of the coil can be effectively decreased, and miniaturization of the coil can be realized.

In this example, in a case where the resin film is used as the film which forms the insulating film between the wire and wire, when heat resistance is required for the insulating film, the film of the material having improved heat resistance is used as the resin film. In this case, a film of polyimide (PI) resin, a film of polyamide (PA) resin, a film of polytetrafluoroethylene (PTFE) resin, a film of polyphenylene sulfide (PPS) resin, and the like may be suitably used.

Among these, the film of the polyimide resin has high temperature resistance and high intensity, the film of the polyamide has characteristics such as high intensity and high thermal conductivity and is low costs, the film of polytetrafluoroethylene resin is high insulation properties, the film of polyphenylene sulfide resin has characteristics in which absorbency is small to be ignored, hydrolysis is difficult, which is low cost, and the like, and therefore, the films may be appropriately used according to the purpose.

Moreover, since the film thickness can be thinner than the thickness in which the coated film of the rectangular copper wire including the insulating coating is superimposed, from the viewpoint for easily handling the film, it is preferable that the film thickness be 50 μm or less. There is an advantage that the rolled rectangular wire can be more used as long as the film is thin. In addition, from the viewpoint of the miniaturization and the low loss of the coil or the core, it is more preferable that the film thickness be 30 μm. Moreover, considering a safety factor with respect to several tens volts of potential differences between coil wires, it is most preferable that the film thickness be 8 to 15 μm which has the voltage resistance of minimum 200V.

In addition, insulation breakdown resistance becomes different according to the material and the thickness. The thickness of the thin film which is relatively easily obtained and the insulation breakdown resistance are as follows.

The insulation breakdown resistance of the film of the polyimide resin has 400 V under the thickness of 12.5 μm, the insulation breakdown resistance of the film of the polyamide resin has 200 V under the thickness of 8 μm, the insulation breakdown resistance of the film of the polytetrafluoroethylene resin has 1500 V under the thickness of 12 μm, and the insulation breakdown resistance of the film of the polyphenylene sulfide resin has 200 V under the thickness of 12 μm. All films satisfy the voltage resistance 200V, and therefore, it is preferable that these are used.

### Example of Experiment

According to the present embodiment, the rectangular wire to which the insulating coating was not attached was wound together in the state of interposing the resin film, the flat-wise coil 10 was configured, and then, it was confirmed that the effects were as follows.

Moreover, the configuration other than the above-described those of the reactor is as follows.

(a) Configuration of Reactor

Here, those having compositions of Fe-2Si (mass %) were used as the soft magnetic powder of the core material.

As the soft magnetic powder of the core material, the soft magnetic powder was atomized using argon gas and used, and the heat treatment of the powder was performed at 750° C.×3 hours in hydrogen for purposes of oxidation prevention and reduction action. Moreover, assuming that the core material is used in an alternating magnetic field of 1 to 50 kHz, after the soft magnetic powder was subjected to the heat treatment, the soft magnetic powder was sieved by a sieve of 250 μm or less and used.

Next, from the viewpoint for controlling magnetic permeability in a proper range or increasing thermal conductivity and from the viewpoint of flowability in the die, the soft magnetic powder having composition of 65 volume % was mixed with PPS (polyphenylene sulfide) resin. Moreover, the resin was melted at approximately 300° C. by a two-axis kneading machine, and the resin was kneaded with the soft magnetic powder and pelletized.

The pellet type soft magnetic mixture was heated at approximately 300° C. by a horizontal inline screw type injection molding apparatus and melted, and after the molten mixture was injected into the die, the mixture was cooled and the core material was manufactured.

The resin covering layer 22 in the encased coil body 24 was made of PPS resin, the thickness in the inner circumferential side of the coil was 0.5 mm, and the thickness of the outer circumferential side, the upper surface side, and the lower surface side of the coil was 1 mm.

In addition, when the coils are superposed in two stages up and down, the insulating sheet having the thickness of 0.5 mm is interposed between the upper and lower coils.

Moreover, the axial center of the core 16 and the axial center of the coil 10, and the center in the axial direction of the core 16 and the center in the axial direction of the coil 10 were arranged and disposed so as to coincide to each other respectively.

### Example B-1

The flat-wise coil (inner diameter of 50 mm and 32 turns) was configured using a rectangular copper wire (thickness of 0.85 mm (including the thickness of attached insulating coating)×width of 9 mm) to which an insulating coating of polyamide-imide having an average film thickness of 25 μm was attached, the flat-wise coil was encased by the resin covering layer 22, and therefore, the encased coil body 24 was configured.

Moreover, the coils 10 are not superposed in two stages different from the coil shown in the above drawings and is configured of a single stage. This point is the same in all Examples except for Example B-3.

### Example A-1

The film of the polyimide resin having a thickness of 12.5 μm was wound together so as to be interposed between wires when a rectangular uncoated copper wire (thickness of 0.8 mm×width of 9 mm) manufactured by rolling was wound, and therefore, the flat-wise coil (inner diameter of 50 mm and 32 turns) was configured, the coil was encased by the resin covering layer 22, and the encased coil body 24 was configured.

As a result, the outer diameter of the coil could be decreased by 2.4 mm. Moreover, as a result, the used amount of the copper wire could be decreased by 6%, and the resin which was used in the resin covering layer could be also decreased by 5%.

### Example B-2

A reactor (outer diameter of φ117.4 mm×height of 31 mm) was configured using the coil of Example B-1.

### Example A-2

A reactor (outer diameter of φ115 mm×height of 31 mm) was configured using the coil of Example A-1.

The reactor of Example A-2 had the same inductance as Example B-2 (in addition, the method of measuring the inductance was as follows).

In Example A-2, the outer diameter of the reactor could be decreased by 2.4 mm. As a result, the used amount of the core material could be decreased by 4%. Moreover, the entire reactor could be decreased by 4% by volume % and could be also decreased by 4% by weight.

In addition, in comparison with Example B-2, the loss at the superimposed current 0 A (zero ampere) could be decreased by 4%. It is assumed that almost the decrease is realized by the effects of the iron loss reduction. Moreover, in comparison with Example B-2, the direct current copper loss at the superimposed current 50 A could be decreased by 6% (the estimation method of the loss is described below).

### Example B-3

The flat-wise coil (inner diameter of 53 mm and 16 turns) was configured so as to be overlapped in two stages up and down using a rectangular copper wire (thickness of 1.25 mm×width of 6 mm) to which an insulating coating of polyamide-imide having an average film thickness of 25 μm was attached, the entire coil was encased by the resin covering layer 22, and therefore, the encased coil body 24 was configured. Moreover, a reactor (outer diameter of φ106 mm×height of 34.5 mm) was configured using the encased coil body.

### Example A-3

The film of the polyamide resin having a thickness of 8 μm was wound together so as to be interposed between wires when a rectangular uncoated copper wire (thickness of 0.6 mm×width of 12 mm and flatness of 20) manufactured by rolling was wound, and therefore, the flat-wise coil (inner diameter of 53 mm and 32 turns) was configured, the entire coil was encased by the resin covering layer 22 from the outside, and the encased coil body 24 was configured.

Moreover, a reactor (outer diameter of φ105 mm×height of 34 mm) was configured using the encased coil body. The inductance of the reactor is the same as that of Example B-3.

In Example A-3, in comparison with Example B-3, the entire reactor could be decreased by 3.0% by mass and could be decreased by 3.3% by volume.

Moreover, the loss at the superimposed current of 0 A in the voltage increase of 300 V→600 V at the switching frequency of 20 kHz could be decreased by 25% (estimation method of the loss is described below). It is assumed that 2 to 3% of the loss is realized by the iron loss reduction and the remaining decrease of the loss is realized by the decrease of the skin effect loss due to using the rectangular wire having a high flatness.

### Example A-4

The film of the polyamide resin having a thickness of 8 μm was wound together so as to be interposed between wires when a rectangular uncoated copper wire (thickness of 0.6 mm×width of 12 mm and flatness of 20) manufactured by rolling was wound, and therefore, the flat-wise coil (inner diameter of 53 mm and 32 turns) was configured, the entire coil was encased by the resin covering layer 22 from the outside, and the encased coil body 24 was configured.

Moreover, a reactor (outer diameter of φ105 mm×height of 34 mm) was configured using the encased coil body. The inductance of the reactor is the same as that of Example B-3.

In Example A-4, in comparison with Example B-3, only the coil could be decreased by mass 70% and the entire reactor could be decreased by mass 25%. Moreover, since the rectangular copper wire with attached insulating coating having high costs could be replaced with the rolled aluminum material which had low costs and was easily processed, the costs due to the coil could be decreased to ⅓ or less.

In addition, estimation of a voltage resistance test and a thermal shock test was performed to all Examples A and Examples B, and all satisfied the references.

Estimation Method

<Inductance Measurement>

In the inductance measurement, the reactor 15 was incorporated to a voltage boosting chopper circuit, predetermined superimposed current of 300 V of an input voltage, 600 V of a voltage after boosting the voltage, and 10 kHz (20 kHz in Example B-3 and Example A-3) of switching frequency was flowed, and the circuit was driven. In addition, a waveform of the current (was measured by mounting a clamp-type ammeter on one terminal) which was flowed into the reactor was measured, and the inductance was calculated from an inclination of the current waveform at a certain time interval.

<Loss Measurement>

The loss measurement was performed according to the following method.

The reactor 15 was fixed on a water-cooled plate. At this time, heat conduction grease was thinly coated between the water-cooled plate and the reactor 15.

At the conditions of 0 A and 50 A of the superimposed current, 300 V→600 V, and 10 kHz (20 kHz in Example B-3 and Example A-3) of switching frequency, the reactor was driven by the voltage boosting chipper circuit similar to the inductance measurement, and the reactor was continuously driven up to a thermal steady state (a state where the internal temperature of the core or the cooling water temperature are not changed in terms of time). Moreover, the cooling water was controlled so as to be flowed into the chiller (constant temperature water cycle device) at 50° C. and 10 liters per minute.

At this time, the internal temperature of the core was measured at several points, and the highest temperature was set to the internal temperature. Thermocouples were embedded to measurement places and the temperature was measured.

At this time, amount of heat was measured from flow rate of the cooling water of the water-cooled plate and the temperature differences of the inlet side and the outlet side, and the amount of heat was set to the loss. The value of the loss at each of the superimposed current 0 A and 50 A was obtained, and the value which subtracts the loss at the superimposed current 0 A from the loss at the superimposed current 50 A was set to the direct current copper loss at the superimposed current 50 A.

Here, if the loss at the superimposed current 0 A is analyzed for each factor, it is as follows,
loss (iron loss) due to loss of core material (sum of hysteresis loss and eddy current loss)
loss (alternating current copper loss) due to heat generation of coil by current amplitude which excludes direct current-superimposed current from current flowed in reactor
loss (skin effect loss) due to skin effect which is generated when high-frequency current flows in conducting wire of coil
loss (proximity effect loss) due to proximity effect in which conducting wires adjacent to each other inhibit flow of current

Since it is difficult to correctly analyze the loss, in Example A and Example B, the loss at the superimposed current 0 A is directly compared.

<Voltage Resistance Measurement>

A voltage resistance measurement was performed as follows.

Here, the reactor 15 was directly disposed on an aluminum base plate, one terminal of a measuring device was connected to one coil terminal 18 of the reactor 15 and the other terminal thereof was connected to the aluminum base plate respectively in a state where the reactor 15 was electrically connected to the aluminum base plate, and in the state, energization was performed, the voltage was gradually increased from alternating current 0 V to 3500 V (volts), and the voltage was held for one second at 3500° C.

At this time, the reactor was acceptable if the flowing current was 10 mA (milliamperes) or less, the reactor was not acceptable if the flowing current was more than 10 mA, and in this manner, the voltage resistance was determined.

<Thermal Shock Test>

A thermal shock test was performed as follows.

(a) [Test Method]: in a thermal shock test device, a low temperature vessel was set to −40° C., a high temperature vessel was set to 150° C., a low temperature exposure and a high temperature exposure were alternately repeated, and 600 cycles were performed. Moreover, each time of the exposures was set to two hours.

(b) [Estimation Reference]: after 600 cycles,

(i) cracks are not present on the outline. (ii) voltage resistance test is performed again and can be clear. (iii) change of inductance is 5% or less before and after the thermal shock test

(c) [Test Device]: the type is TSA-41L-A, which is manufactured from ESPEC Corporation.

As described above, the embodiment of the present invention is described. However, the embodiment is only an example.

For example, in the above-described embodiment, when the encased coil body 24 is molded, first, the outer circumferential covering portion 46 is molded, and subsequently, the inner circumferential covering portion 50 is molded. However, according to circumstances, the coil 10 is held and constrained to the outer circumferential surface using the primary molding die in the primary molding, the inner circumferential covering portion 50 is molded, and thereafter, the outer circumferential covering portion 46 may be molded, and the primary molded body 22-1 and the secondary molded body 22-2 in the resin covering layer 22 or the primary molded body 16-1 and the secondary molded body 16-2 in the core 16 may be molded in various shapes other than the above-described example.

### DESCRIPTION OF NUMERAL REFERENCES

6: wire
7: resin film
7A: insulating film
10: coil
15: reactor
16: core
16-1 and 22-1: primary molded body
16-2 and 22-2: secondary molded body
22: resin covering layer
24: encased coil body
25: outer circumferential molded portion
26: bottom portion
30: opening
32: inner circumferential molded portion
34: cover portion
40: recess
46: outer circumferential covering portion
50: inner circumferential covering portion
54 and 84: primary molding die
66, 80, 94, and 104: cavity
70 and 96: secondary molding die
110: container
114: aluminum case (reactor case)
P1 and P2: boundary surface

1. A reactor, which comprises: a molded body configured of a mixture including a soft magnetic powder and a resin as a core, and an electric coil configured by winding a wire in a state where an insulating layer is interposed between said wires, which is configured so as to be integrated with the core in an embedded state in an inner portion of the core,
wherein the coil is encased in a state of being entirely enclosed with an electrically insulating resin from the outside to configure an encased coil body, and
the core is configured of a molded body formed by injection-molding a mixture including the soft magnetic powder and a thermoplastic resin in a state where the encased coil body is integrally embedded in the inner portion of the core.

2. The reactor according to claim 1,
wherein in the core, a primary molded body, which includes a tubular outer circumferential molded portion contacting an outer circumferential surface of the encased coil body, and a secondary molded body, which includes an inner circumferential molded portion contacting an inner circumferential surface of the encased coil body, are joined to each other at a boundary surface and are integrated.

3. The reactor according to claim 1,
wherein the resin covering layer of the encased coil body is configured of an injection-molded body of an insulating thermoplastic resin; and a molded body, which includes an outer circumferential covering portion covering an outer circumferential surface of the coil, and another, molded body, which includes an inner circumferential covering portion covering an inner circumferential surface of the coil, are joined and integrated.

4. The reactor according to claim 1,
wherein the coil comprises a coil which is configured by winding a rectangular wire, the coil is configured in a shape in which a plurality of coil blocks are superposed in the same axis via an insulating sheet in a height direction which is a coil axial direction and/or in a radial direction and in a direction perpendicular to a winding and superposing direction of the wire in a state where the plurality of coil blocks ate connected to one another, and an aspect ratio A/B is in a range of 0.7 to 1.8 wherein when a height size is taken as A and a width direction size which is a radial direction size is taken as B in a longitudinal cross-section of the coil including the insulating sheet.

5. The reactor according to claim 4,
wherein the coil comprises a flat-wise coil which is configured by winding the rectangular wire in a thickness direction of the wire, and the coil blocks are stacked in a plurality of stages in the height direction.

6. The reactor according to claim 1,
wherein the soft magnetic powder comprises a powder of pure Fe or a powder of an Fe based alloy having a composition containing 0.2 to 9.0 mass % of Si.

7. The reactor according to claim 1,
wherein the inner circumferential portion and the outer circumferential portion of the coil in the core are configured of materials which are different from each other,
the outer circumferential portion is configured of a core material which uses a powder of a low Si material configured of pure Fe or an Fe-based alloy containing 0.2 to 4.0 mass of Si as the soft magnetic powder, and
the inner circumferential portion is configured of a core material which uses powder of a high Si material configured of an Fe-based alloy containing 1.5 to 9.0 mass of Si as the soft magnetic powder and having a larger Si content than the soft magnetic powder of the core material of the outer circumferential portion.

8. The reactor according to claim 7,
wherein the Si content of the high Si material is 1.5 mass or more larger than a Si content of the low Si material.

9. The reactor according to claim 1,
wherein the coil comprises a flat-wise coil in which a rectangular wire to which an insulating coating is not attached is wound in the thickness direction of the wire in a state where an insulating film molded in a film shape in advance is interposed between said wires.

10. The reactor according to claim 1,
wherein the core is integrally injection-molded with a container portion of a reactor case.

11. The reactor according to claim 1,
wherein the reactor is to be used in an alternating magnetic field with a frequency of 1 to 50 kHz.

12. A method of manufacture for a reactor according to claim 1,
wherein the reactor is obtained by performing
a step A of encasing the coil with the electrically insulating resin in a state where the coil is entirely enclosed from the outside to mold the encased coil body; and
a step B of setting the encased coil body to a molding die and injection-molding a mixture including the soft magnetic powder and the thermoplastic resin in a state where the encased coil body is enclosed, thereby molding the core and also integrating the coil in an embedded state in the inner portion of the core.

13. The method of manufacture for a reactor according to claim 12,
wherein the step B of injection-molding the core is divided into
a step B-1 in which a primary molded body which includes a tubular outer' circumferential molded portion of the core contacting the outer circumferential surface of the encased coil body and includes a shape having an opening for inserting the encased coil body in one end side in the coil axial direction is injection-molded in advance in a primary molding die for the core, and
a step B-2 in which a secondary molded body which includes an inner circumferential molded portion contacting the inner circumferential surface of the encased coil body is molded in a secondary molding die for the core,
wherein in the step B-2, the secondary molded body which includes the inner circumferential molded portion is molded in a state where the encased coil body is fitted to the outer circumferential molded portion of the primary molded body obtained through the step B˜I in the state of being innerly fitted and the outer circumferential molded portion is held so as to be constrained in the radial direction [Tom the outer circumferential side in the secondary molding die for the core, and simultaneously, the secondary molded body, the primary molded body, and the encased coil body are integrated with one another.

14. The method of manufacture for a reactor according to claim 13 wherein in the step B-1 in which the primary molded body is molded, a bottom portion of the core opposite to the opening is molded along with the outer circumferential molded portion, whereby the primary molded body is formed in a container shape having a bottom portion in which the encased coil body is housed and held in the inner portion thereof.

15. The method of manufacture for a reactor according to claim 14,
wherein the primary molded body is molded so as to have a height in which the encased coil body is housed over the entire height of a recess of the inner portion.

16. The method of manufacture for a reactor according to claim 13,
wherein in the step B-2 in which the secondary molded body is molded, a cover portion which closes the opening is molded along with the inner circumferential molded portion.

17. The method of manufacture for a reactor according to claim 12,
wherein in the step A in which the encased coil body is molded, the resin covering layer which encases the coil in a state of enclosing the coil is injection-molded by the thermoplastic resin, and the injection-molding is performed with dividing the step A into a step A-1 and a step A-2,
wherein the step A-1 includes contacting a primary molding die for the resin covering layer with respect to an inner circumferential surface or an outer circumferential surface of the coil, and injecting a resin material into a primary molding cavity of the primary molding die which is formed on the outer circumferential side or the inner circumferential side of the coil in a state where the coil is constrained by the primary molding die so as to be positioned in a radial direction in the inner circumferential surface or the outer circumferential surface, thereby molding a primary molded body which includes an outer circumferential covering portion or an inner circumferential covering portion in the resin covering layer and also integrating the primary molded body and the coil, and
the step A-2 includes, after the step A-1, setting the primary molded body along with the coil to a secondary molding die for the resin covering layer, and injecting the resin material into a secondary molding cavity of the secondary molding die which is formed on the inner circumferential side or the outer circumferential side of the coil) thereby molding a secondary molded body which includes the inner circumferential covering portion or the outer circumferential covering portion in the resin covering layer and also integrating the secondary molded body, the coil) and the primary molded body.

18. The method of manufacture for a reactor according to claim 12,
wherein the coil is obtained by winding a long rectangular wire along with an insulating film molded in a long film shape with a width corresponding to the rectangular wire in advance) so as to interpose said film between said wires.

19. The reactor according to claim 2,
wherein the resin covering layer of the encased coil body is configured of an injection-molded body of an insulating thermoplastic resin; and a molded body, which includes an outer circumferential covering portion covering an outer circumferential surface of the coil, and another, molded body, which includes an inner circumferential covering portion covering an inner circumferential surface of the coil, are joined and integrated.

20. The reactor according to claim 2,
wherein the coil is a coil which is configured by winding a rectangular wire, the coil is configured in a shape in which a plurality of coil blocks are superposed in the same axis via an insulating sheet in a height direction which is a coil axial direction and/or in a radial direction and in a direction perpendicular to a winding and superposing direction of the wire in a state where the plurality of coil blocks ate connected to one another, and an aspect ratio A/B is in a range of 0.7 to 1.8 wherein when a height size is taken as A and a width direction size which is a radial direction size is taken as B in a longitudinal cross-section of the coil including the insulating sheet.
